(19) United States
(12) Patent Application Publication
(10) Pub. No.: US 2026/0044030 A1
(43) Pub. Date: Feb. 12, 2026

(54) Multi-dimensional convolution operation enabled by photonic frequency synthetic dimensions

(71) Applicant: The Board of Trustees of the Leland Stanford Junior University, Stanford, CA (US)

(72) Inventors: Lingling Fan, Stanford, CA (US); Zhexin Zhao, Redmond, WA (US); Kai Wang, Montréal (CA); Shanhui Fan, Stanford, CA (US)

(21) Appl. No.: 18/865,794

(22) PCT Filed: Jun. 6, 2023
(86) PCT No.: PCT/US2023/024599

§ 371 Date: Nov. 14, 2024

Related U.S. Application Data
(60) Provisional application No. 63/349,413, filed on Jun. 6, 2022.

(51) Int. Cl. G02F 1/035; G06N 3/0464; G06N 3/067

(52) U.S. Cl. CPC G02F 1/035; G06N 3/0464; G06N 3/067

(57) ABSTRACT

We provide a method for optical convolution based on frequency synthetic dimensions using a single optical ring resonator undergoing dynamic modulations. The convolution is achieved using the scattering matrix of such a modulated system with discrete frequency input matching the free spectral range of the ring resonator. We use both a phase modulator and an amplitude modulator to obtain both unitary and non-unitary scattering matrices, analogous to non-Hermitian physics in synthetic dimensions.

### FIELD OF THE INVENTION

This invention relates to optically performing convolutions.

### BACKGROUND

Multi-dimensional convolution lies at the cornerstone of artificial intelligence and represents the most computationally intensive step in convolutional neural networks. However, the hardware performance using digital electronics for such convolution operations is constrained by low speed operation, high power consumption, and poor scalability to large-sized data.

More specifically, some disadvantages of conventional approaches are as followed. Digital electronic hardware for processing multi-dimensional convolution is energy-consuming due to the data movement bottleneck. Optical neural networks (ONNs) can perform linear algebra tasks more energy-efficiently by simply propagating the optical signals through a structure. However, conventional ONNs are not compact or scalable to process input data and encode parameters on large scales. For example, a linear transformation of N input signals is described by an N×N matrix with O(N²) degrees of freedom. In a Mach-Zehnder interferometer ONN implementation, the area of the device also scales as O(N²) in order to provide the degrees of freedom in the N by N matrix. This undesirably requires a large spatial footprint and high I/O and signal controls, which are not suitable for compact implementations or energy-limited edge devices.

Accordingly, it would be an advance in the art to provide improved optical signal processing, especially in connection with convolution.

### SUMMARY

Our work points to a direction of using optical computing to remove the computational bottleneck in traditional electronic circuits and may be useful in improving machine learning hardware in artificial intelligence applications.

In this work, we provide a scheme for convolution based on frequency synthetic dimensions using a single optical ring resonator undergoing dynamic modulations. The convolution is achieved using the scattering matrix of such a modulated system with discrete frequency input matching the free spectral range of the ring resonator. We use both a phase modulator and an amplitude modulator to obtain both unitary and non-unitary scattering matrices, analogous to non-Hermitian physics in synthetic dimensions.

We analytically develop a deterministic, closed-form expression to directly obtain the modulation parameters for desired convolution kernels. We show that the kernel implemented can perform multi-dimensional convolutions, analogous to the working principles of synthesizing higher dimensions using multiple orders of couplings developed in synthetic dimensions.

Specifically, we verify such convolution with two-dimensional images. We introduce an approach to performing the convolution on large-scale images by judiciously slicing the input data, without the need for high modulation frequencies. We also extend our scheme to higher-dimensional convolution cases where the input and output data contain several channels such as videos and LIDAR (light detection and ranging) scans. Our scheme provides a new means of multi-dimensional convolution in a compact and configurable manner.

We also provide experimental demonstrations of these principles.

Various applications are possible. The ring-resonator-based convolution in our work would be useful in improving machine learning hardware for state-of-the-art artificial intelligence performances. We have demonstrated 2D convolution which is useful for digital image processing, by extracting spatial features within a single two-dimensional image. We extend our applications for a broader setting which produces higher-dimensional input data sets. For example, LIDAR scans produce an array of images at various spatial depths, and a video consists of an array of images at different temporal frames. For processing these data sets, higher-dimensional convolution is important. For the processing of LIDAR data sets, three-dimensional (3D) convolution is useful in identifying 3D objects. For video processing, 3D convolution is useful in recognizing and predicting motion. Thus our work may enable specialized hardware for such computations.

### BRIEF DESCRIPTION OF THE DRAWINGS

FIG. 1 shows a first exemplary embodiment of the invention.

FIG. 1B shows an exemplary convolution.

FIGS. 2A-D show a mapping between 1D and 2D data representations to enable convolving 2D data on hardware that provides a 1D convolution capability.

FIG. 3A shows an input image.

FIGS. 3B and 3C show convolution kernel frequency components for Gaussian and Laplacian kernels, respectively.

FIGS. 3D and 3E show convolution kernel time-domain optical modulation signals for Gaussian and Laplacian kernels, respectively.

FIGS. 3F and 3G are gray scale heat maps of the scattering matrices for Gaussian and Laplacian kernels, respectively.

FIGS. 3H and 3I show output images obtained by convolving the image of FIG. 3A with Gaussian and Laplacian kernels, respectively.

FIG. 4A shows an input image.

FIGS. 4B and 4C show convolution kernel frequency components for Sobel x and Sobel y kernels, respectively.

FIGS. 4D and 4E show convolution kernel time-domain optical modulation signals for Sobel x and Sobel y kernels, respectively.

FIGS. 4F and 4G are gray scale heat maps of the scattering matrices for Sobel x and Sobel y kernels, respectively.

FIGS. 4H and 4I show output images obtained by convolving the image of FIG. 3A with Sobel x and Sobel y kernels, respectively.

FIG. 5A shows an approach for reducing the required modulator bandwidth by subdividing an input 2D data set.

FIG. 5B is an input image.

FIGS. 5C, 5D, 5E show the result of convolving the image of FIG. 5B with and without using the image slicing of FIG. 5A.

FIGS. 5F and 5G compare convolution kernel frequency components without image slicing and with image slicing, respectively

FIG. 6A schematically shows a 3D convolution.

FIG. 6B shows convolution kernel frequency components for an exemplary 3D kernel.

FIG. 6C shows convolution kernel time-domain optical modulation signals for the 3D kernel of FIG. 6B.

FIG. 6D shows 5 frames of a 3D data set.

FIG. 6E shows the result of convolving the data of FIG. 6D with the kernel of FIG. 6B.

FIG. 7 shows a second exemplary embodiment of the invention.

FIGS. 8A-8H relate to experimental synthesis of various convolution kernels.

FIGS. 9A-9F relate to experimental synthesis of various convolution kernels having an additive offset.

FIGS. 10A-E relate to an experimental demonstration of convolution of multi-frequency inputs with a kernel.

FIGS. 11A-D relate to an all-optical implementation of convolution kernels having an additive offset.

### DETAILED DESCRIPTION

Section A describes general principles relating to embodiments of the invention. Section B is a detailed theoretical description. Section C describes some experiments that have demonstrated the concepts of this work.

### A) General Principles

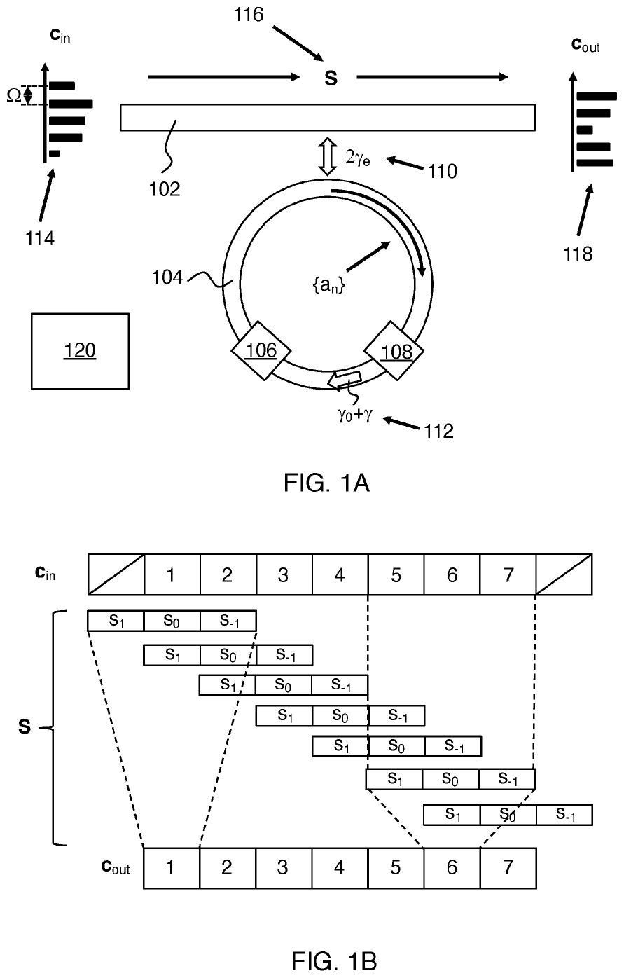

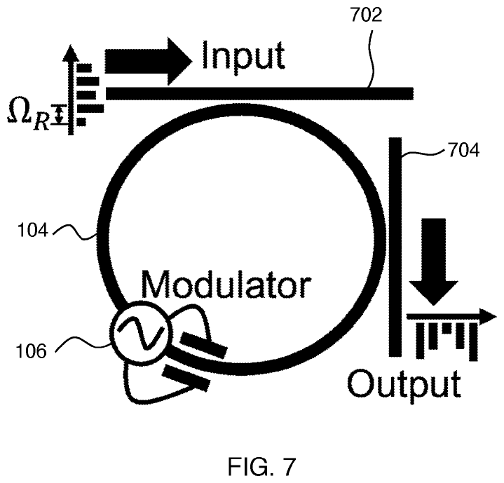

An exemplary embodiment of the invention is apparatus including: an optical resonator (e.g., 104 on FIG. 1A) coupled to at least one optical waveguide (e.g., 102 on FIG. 1A, 702 and 704 on FIG. 7). The optical resonator includes an amplitude modulator (e.g., 106 on FIG. 1A) and a phase modulator (e.g., 108 on FIG. 1A). The optical waveguide 102 is configured to receive a waveguide input that is an optical frequency comb having multiple optical frequency components (e.g., 114 on FIG. 1A).

The apparatus also includes a signal controller (e.g., 120 on FIG. 1A). For simplicity, connections between this controller and other components are not shown, since they are conventional and can be made in any known way. Signal controller 120 is configured to electrically drive the amplitude modulator with a composite amplitude electrical signal, and is also configured to electrically drive the phase modulator with a composite phase electrical signal. Here “composite” electrical signals are electrical signals having two or more frequency components (and typically having 10s or more frequency components). Here the amplitude and phase composite signals are at the same frequency components.

The composite amplitude electrical signal and the composite phase electrical signal are selected to implement a predetermined convolution kernel, as described in detail below. The result of this is that an input-output relation (e.g., scattering matrix S (116) on FIG. 1A) between the waveguide input cᵢₙ and a waveguide output cₒᵤₜ is a convolution using frequencies of the optical frequency comb as a basis.

Preferably, the free spectral range of the optical resonator is the same as a frequency spacing of the optical frequency comb.

The convolution kernel can be selected from the group consisting of: 1-D convolution kernels, 2-D convolution kernels, and 3-D convolution kernels. The convolution kernel can be selected from the group consisting of: Gaussian kernels, Laplacian kernels, Sobel x kernels, and Sobel y kernels. These kernels are listed to provide examples, and convolution with any kernel can be implemented with this approach.

An input 2-D or 3-D data set can be divided into nonoverlapping partial data sets to reduce a bandwidth of the composite electrical amplitude and phase signals needed to implement the convolution kernel. This approach can also be extended to reduce the bandwidth needed for convolutions of data in any number of dimensions >1.

The composite electrical amplitude and phase signals can be (and preferably are) determined in closed form from the convolution kernel.

In some cases, it is desirable to optically implement an additive offset of a convolution kernel. An exemplary embodiment of the invention along these lines further includes an optical splitter (e.g., 1108 on FIG. 11D), an optical combiner (e.g., 1110 on FIG. 11D), and an optical loss/gain element (e.g., 1106 on FIG. 11D).

In operation, an optical input is received by the optical splitter 1108 and divided into the waveguide input and a single-frequency offset optical input. The single-frequency offset optical input (e.g., propagating in waveguide 1102) is received by the optical loss/gain element to provide an adjusted offset. The remainder of the original input light is convolved in the ring resonator as described above. The adjusted offset and the waveguide output is combined with the optical combiner. With this approach (e.g., as shown on FIG. 11D), an additive offset term in the convolution kernel can be implemented by the optical loss/gain element.

As indicated in the examples of FIGS. 1 and 7, a single waveguide can be used for input and output, or separate waveguides can be used for input and output. Thus the preceding description refers in general terms to a “waveguide input” and “waveguide output” without committing to one alternative or the other. More specifically, these alternatives are as follows. A single optical waveguide (e.g., 102 on FIG. 1) can provide the waveguide input and receive the waveguide output, or an input optical waveguide (e.g., 702 on FIG. 7) can provide the waveguide input and an output optical waveguide (e.g., 704 on FIG. 7) can receive the waveguide output.

### B) Theoretical Development

### B1) Introduction

Artificial neural networks have demonstrated state-of-the-art performance in machine-learning tasks such as image, video, speech, and text processing. Among these networks, convolutional neural networks (CNNs) play a particularly important role in extracting hierarchical features from complex raw data, as they mimic characteristics of biological neural perception. In addition, CNNs are capable of making correct predictions based on unseen data, without increasing parameter complexities.

In CNNs, an important class of tasks, including spatiotemporal perception, require the convolution of large-scale data encoded in multidimensional matrices, which is energy consuming using conventional electronic hardware due to the data-movement bottleneck. To overcome this bottleneck, optical neural networks (ONNs) perform linear algebra tasks more energy efficiently by simply propagating the optical signals through a structure. ONNs can also increase computing speed and lower energy consumption. For example, Mach-Zehnder interferometers (MZIs) have been employed in integrated photonic circuits to achieve linear transformations. Microring resonators have been used as reservoir computing neurons. Diffractive and scattering media have been used as analog hardware platforms for image and vowel classification tasks. Recently, state-of-the-art ONNs with high parallelism and high-speed operations have been demonstrated, with the speed reaching 10¹² operations per second.

For many computational tasks, ONNs need to be compact and scalable to process input data and encode parameters on large scales. Linear transformation of N input signals is described by a N×N matrix with O(N²) degrees of freedom. In the MZI implementation, the area of the device also scales as O(N²) in order to provide the degrees of freedom in the N×N matrix. Recently, there have been efforts to realize more scalable devices for linear transformation, by employing the internal degrees of freedom of photons. Frequency is an important intrinsic degree of freedom of light and its manipulation based on the concept of the synthetic frequency dimension in dynamically modulated ring resonators has attracted growing interest for both the explorations of fundamental physics and optical information processing. Compared with spatial encoding, the synthetic frequency dimension enables a compact spatial footprint for manipulating photons in both classical and quantum domains.

Using the photonic synthetic frequency dimension, a recent work (Buddhiraju et al., Nat. Commun. 12, 2401, 2021) shows that it is possible to realize an arbitrary linear transformation with multiple rings connected in series. In that work, to realize the linear transformation of N input frequencies, the number of rings scales as N. Part of the required N² degrees of freedom is now compactly encoded in the modulation tones, as opposed to the spatial coupling constants as in the MZI configuration.

The work of (Buddhiraju et al.) has implemented a linear transformation described by a dense N×N matrix. For this purpose, small auxiliary rings have been introduced to break the natural translational symmetry in frequency space for a dynamically modulated ring. Here, we note that for convolution tasks, it is not necessary to break such translational symmetry. Instead, the natural translational symmetry along the frequency dimension in modulated ring resonators can be harnessed to perform convolutions, resulting in a configuration that is far simpler for practical implementations. Moreover, in synthetic frequency dimensions, modulations at higher multiples of the free spectral range (FSR) of a resonator enable long-range couplings between farther-apart frequency modes. Such long-range coupling has been used in the literature to synthesize a multidimensional Hamiltonian. It should be of interest to extend this approach to multidimensional convolutions and hence accelerate signal processing.

In this work, we describe a scheme for convolution based on synthetic frequency dimensions using a single optical ring resonator undergoing dynamic modulations. The convolution is achieved using the scattering matrix of such a modulated system with a discrete frequency input matching the free spectral range of the ring resonator. We use both a phase modulator and an amplitude modulator to obtain both unitary and nonunitary scattering matrices, analogous to recent experiments demonstrating non-Hermitian physics in synthetic dimensions. We analytically develop a deterministic closed-form expression to directly obtain the modulation parameters for the desired convolution kernels. We show that the kernel implemented can perform multidimensional convolutions, analogous to the working principles of synthesizing higher dimensions using multiple orders of couplings developed in synthetic dimensions. Specifically, we verify such convolution with two-dimensional (2D) images. We introduce an approach to performing the convolution on large-scale images by judiciously slicing the input data, without the need for high modulation frequencies. We also extend our scheme to higher-dimensional convolution cases where the input and output data contain several channels, such as videos and LIDAR scans. Our scheme provides a means of achieving multidimensional convolution in a compact and configurable manner.

This section is organized as follows. In subsection B2, we present the working principles for convolution by using the photonic synthetic frequency dimension. In subsection B3, we demonstrate 2D convolution in images, highlighting some of the detailed considerations in modulation for symmetric and asymmetric kernel matrices. In subsection B4, we discuss an approach that slices the image in order to reduce the required modulation bandwidth. This slicing approach is of interest for convolution on a larger image. In subsection B5, we demonstrate a three-dimensional (3D) convolution case. In subsection B6, we provide concluding remarks.

### B2) Theory

### B2a) the Synthetic Frequency Dimension

### B2a1) Modulated Ring Resonator

FIG. 1A is a schematic of the modulated ring with simultaneous modulation in amplitude and phase at the frequency of free spectral range Ω/2π and its integer multiples. The ring supports resonant modes {an} and has an input-output coupling rate γₑ and an intrinsic decay rate γ₀. The scattering matrix S (116) from the modulated ring resonator converts the input cᵢₙ (114) to the output cₒᵤₜ (118). More specifically, waveguide 102 is coupled to ring resonator 104. Ring resonator 104 includes amplitude modulator 106 and phase modulator 108. 110 schematically indicates the coupling between waveguide 102 and resonator 104. 112 schematically indicates the resonator loss.

FIG. 1B shows an example of a one-dimensional (1D) convolution operation with the kernels s₋₁, s₀ and s₁ that maps the input cᵢₙ to the output cₒᵤₜ, which can be completed with a scattering matrix S of translational symmetry.

This work uses a dynamically modulated ring resonator sketched in FIG. 1A. The ring resonator and the coupling waveguide are both formed by a single-mode waveguide. In the absence of group-velocity dispersion and modulation, the ring resonator supports equally spaced longitudinal modes ωₙ=ω₀+nΩ, where n is an integer indexing the modes that are separated by the FSR as given by Ω/2π=c/n_{g} [symbol] , with ω₀, c, n_{g}, and [symbol] being the central frequency, the speed of light, the group index, and the circumference of the ring, respectively. Inside the ring resonator, we place a phase modulator and an amplitude modulator. Both modulators are assumed to be spatially compact and, together, the two modulators produce a time-dependent transmission factor T(t),

$$T ( t ) = {T}_{Ph} ( t ) {T}_{Am} ( t ) , \qquad ( 1 )$$

$$where$$

$${T}_{Ph} ( t ) = exp [ - j {\sum }_{m \geq 1} {A}_{m} cos ( m Ω t + {α}_{m} ) ] , \qquad ( 2 )$$

$${T}_{Am} ( t ) = exp [ {\sum }_{m \geq 1} {B}_{m} sin ( m Ω t + {β}_{m} ) - γ {t}_{R} ] , \qquad ( 3 )$$

correspond to the time-dependent transmission factors for the phase and amplitude modulators, respectively. Aₘ(Bₘ) and αₘ(βₘ) describe the magnitude and phase angle of the mth order of the frequency components in the phase (amplitude) modulations, respectively. The time-independent term γt_{R} in the exponent of Eq. (3), where γ>0 and t_{R}=2π/Ω denotes the round-trip time of the ring, describes a background loss due to the amplitude modulator. This loss is important in order to ensure the passivity of the device, i.e., a device without the need of amplification, as we discuss in more detail in subsection B2c. We choose the modulation signal to have the same period as t_{R} such that T(t)=T(t+t_{R}), so that a large number of modes can be resonantly coupled together.

In our discussion, we assume that all the modes of interest in the ring resonator in the absence of modulation have the same intrinsic decay rate γ₀, which accounts for all sorts of internal losses including, but not limited to, waveguide bending loss and material loss. We also assume that the input-output coupling rate γₑ between the coupling waveguide and the ring resonator is the same for all the modes of interest in the ring resonator. To ensure that the neighboring resonant modes are well separated, the line width of each mode γₑ+γ₀ in the absence of modulation is required to be much smaller than the FSR. Throughout this section, we assume that we use an in-coupling beam splitter with a power splitting ratio of z=50% between the input port and the cavity, where the corresponding input-output coupling rate is γₑ=−ln(1−z)/2t_{R}≈0.0552Ω.

### B2a2) Input and Output

We compute the input-output relation for the setup discussed in the previous section. For this purpose, we denote the amplitude of the nth mode in the ring resonator as aₙ(τ)exp(jωₙt), where τ is a slow time variable depending on the number of round trips. Similarly, we denote the amplitude of the modes in the coupling waveguide with a frequency centered around ωₙ at the input and output ports as c_{in,n}(τ)exp(jωₙt) and c_{out,n}(τ)exp(jωₙt), respectively. Thus, the dynamics of the modulated ring resonator coupling to a waveguide can be described by the formalism of the temporal coupled-mode theory:

$$\frac{d}{d τ} {a}_{n} = - j {\sum }_{m \geq 1} [ {κ}_{m} {a}_{n - m} + {κ}_{- m} {a}_{n + m} ] - ( γ + {γ}_{0} + {γ}_{e} ) {a}_{n} + j \sqrt{2 {γ}_{e}} {c}_{in , n} , \qquad ( 4 )$$

$${c}_{out , n} = {c}_{in , n} + j \sqrt{2 {γ}_{e}} {a}_{n} , \qquad ( 5 )$$

where the coupling coefficients induced by the dynamic modulation are given by

$${κ}_{+ m} = \frac{1}{2 {t}_{R}} ( {A}_{m} {e}^{+ j {α}_{m}} + {B}_{m} {e}^{+ j {β}_{m}} ) , \qquad ( 6 )$$

$${κ}_{- m} = \frac{1}{2 {t}_{R}} ( {A}_{m} {e}^{- j {α}_{m}} - {B}_{m} {e}^{- j {β}_{m}} ) , \qquad ( 7 )$$

where m≥1. In obtaining Eqs. (6) and (7), it is assumed that the modulation magnitudes |Aₘ| and |Bₘ| are small. We observe that Eqs. (4) and (5) have a translational symmetry along the frequency axis, which is desirable for convolution operation.

We further assume that the input wave consists of a sequence of equally spaced frequency components, where the frequency separation is 2 and the frequency detuning with respect to the resonant frequencies of the ring is Δω, i.e., c_{in,n}(τ)=c_{in,n}exp(jΔωτ). In this case, the steady-state amplitudes of the modes in the ring resonator and at the output port take the similar forms aₙ(τ)=aₙexp(jΔωτ) and c_{out,n} (t)=c_{out,n}exp(jΔωτ), respectively. As we consider the on-resonance coupling in the system throughout, the frequency detuning Δω=0. In the representation of discrete frequency modes, a=[ . . . , a₋₁, a₀, a₁, . . . ]^{T}, cᵢₙ=[ . . . , c_{in,-1}, c_{in, 0}, c_{in,1}, . . . ]^{T}, and cₒᵤₜ=[ . . . , c_{out,-1}, c_{out,0}, c_{out,1}, . . . ]^{T}, we obtain the scattering matrix S, where cₒᵤₜ=Scᵢₙ, from Eqs. (4) and (5):

$$S = I + j 2 {{γ}_{e} [ K - j ( γ + {γ}_{0} + {γ}_{e} ) I ]}^{- 1} , \qquad ( 8 )$$

where K is the matrix that contains the coupling coefficients induced by the modulation with the matrix element as given by K_{m,n}=Kₘ₋ₙ(n≠m) and I is the identity matrix. Therefore, the matrix elements of S satisfy S_{m,n}=sₘ₋ₙ and thus have a translational symmetry along the frequency axis—as expected, since the system described by Eqs. (4) and (5) is translationally invariant along the frequency axis.

### B2b) Convolution-Kernel Generation

Equation (8) describes a convolution operation, since

$${c}_{out , m} = {\sum }_{n} {S}_{m , n} {c}_{in , n} = {\sum }_{n} {s}_{- n} {c}_{in , m + n} \qquad ( 9 )$$

with sₙ being the convolution kernel. From Eq. (9), we illustrate a simple example of one-dimensional (1D) convolution in FIG. 1(b), where each frequency site of cₒᵤₜ is given by a corresponding frequency site of cᵢₙ with its local neighbors, averaged with the weights given by the kernel s. The 1D convolution is widely used in a number of applications including natural-language processing and time-series modeling.

Equations (8) and (9) allow us to determine the convolution kernel sₙ from the modulation profile as described in Eqs. (2) and (3). For an infinite-dimensional matrix A having translational symmetry, i.e., A_{m,n}=aₘ₋ₙ, its inverse A⁻¹ also has translational symmetry, i.e., (A⁻¹)_{m,n}=ãₘ₋ₙ where ãₘ is given by

$${\tilde{a}}_{m} = \frac{1}{2 π} {\int }_{0}^{2 π} {e}^{- jm θ} {( {\sum }_{n} {e}^{jn θ} {a}_{n} )}^{- 1} d θ . \qquad ( 10 )$$

Applying Eq. (10) to Eq. (8), we obtain

$${s}_{m} = {δ}_{m , 0} + \frac{j {γ}_{e}}{π} {\int }_{0}^{2 π} {e}^{- jm θ} {( {\sum }_{n} {e}^{jn θ} {κ}_{n} )}^{- 1} d θ , \qquad ( 11 )$$

where we define κ₀=−j(γ+γ₀+γₑ) and κₘ(m≠0) is defined in Eqs. (6) and (7).

Equation (11) enables us to determine the convolution kernel from the modulation profile. On the other hand, in typical applications, the convolution kernel sₙ is prescribed and the task is then to choose the modulation profile, as well as other parameters of the device, to achieve the desired kernel. For this purpose, we derive the corresponding modulation parameters from Eq. (11) as

$${κ}_{m} = \frac{j {γ}_{e}}{π} {\int }_{0}^{2 π} {{e}^{- jm θ} [ {\sum }_{n} {e}^{jn θ} ( {s}_{n} - {δ}_{n , 0} ) ]}^{- 1} d θ . \qquad ( 12 )$$

From Eq. (12), and using Eqs. (6) and (7), we find the parameters for the amplitude and phase modulations, as well as the decay rate of the resonator as

$${A}_{m} {e}^{j {α}_{m}} = {t}_{R} ( {κ}_{+ m} + {κ}_{- m}^{*} ) , \qquad ( 13 )$$

$${B}_{m} {e}^{j {β}_{m}} = {t}_{R} ( {κ}_{+ m} - {κ}_{- m}^{*} ) , \qquad ( 14 )$$

$$γ + {γ}_{0} + {γ}_{e} = j {κ}_{0} . \qquad ( 15 )$$

Equations (12)-(15) provide an analytic approach to finding the required modulation wave forms and decay rates for any desired kernel. The implementation of a kernel with N nonzero elements requires N modulation frequencies in both the amplitude and the phase modulation.

### B2c) Passivity Constraint

For convolution operations in digital signal processing, the norm of the kernel s in Eq. (9) does not play a significant role. In our physical implementation, however, the norm of the kernel is important, since one typically prefers to use a passive system without net energy gain. As a sufficient condition for a passive system, the time-dependent transmission

$$s ( t ) = {\sum }_{m} {s}_{m} {e}^{jm Ω t} \qquad ( 16 )$$

is required to satisfy

$$\vert s ( t ) \vert \leq 1 \qquad ( 17 )$$

for every t. We note that Eq. (17) is not a necessary condition for a passive system, as has also been noted in the literature. For a given prescribed kernel

$${s}_{m}^{′} ,$$

we define

$$η = {max}_{t ∈ ( 0 , 2 π / Ω ]} \vert {\sum }_{m} {s}_{m}^{′} exp ( jm Ω t ) \vert , \qquad ( 18 )$$

and implement the kernel with the scaling factor 1.1n:

$${s}_{m} = {s}_{m}^{′} / ( 1.1 η ) . \qquad ( 19 )$$

Here, the factor of 1.1 is introduced so that the implemented system is slightly lossy.

### B2d) Two-Dimensional Convolution

Equation (9) has the form of a 1D convolution. Here, we establish how we can perform higher-dimensional convolutions in such a discrete frequency system, by judiciously arranging input higher-dimensional matrices into a vector and accordingly converting the higher-dimensional kernel into a 1D kernel. We illustrate this by considering 2D convolution first.

A convolution between a 2D matrix A of size H×W and a kernel F of size (2P₁+1)×(2P₂+1) produces an output matrix O of size (H−2P₁)×(W−2P₂). In many applications, it is desirable that the output matrix has the same size as A. For this purpose, it is common to pad the matrix A with zero-valued elements. The entire input matrix X with paddings that ensure same size of the output as A is therefore of size L₁×L₂ with L₁=H+2P₁ and L₂=W+2P₂. Here, the kernel sizes are chosen as odd numbers, as is typical in convolutional neural networks and image processing. For the kernel matrix F, we index the first and second dimensions as [−P₁, . . . , P₁] and [−P₂, . . . , P₂], respectively. We index the first and second dimensions of X as [−P₁, . . . , H+P₁−1] and [−P₂, . . . , W+P₂−1], respectively. The matrix A occupies a block in X indexed from 0 to H−1 for the first dimension and 0 to W−1 for the second dimension. The rest of the matrix X is padded with zero-valued elements. The output data matrix Y by convolving X with F is of size H×W. Mathematically, this 2D convolution can be described as

$${Y}_{i , j} = {\sum }_{p = - {P}_{1}}^{{P}_{1}} {\sum }_{q = - {P}_{2}}^{{P}_{2}} {F}_{- p , - q} {X}_{i + p , j + q} , \qquad ( 20 )$$

where i∈[0, . . . , H−1] and j∈[0, . . . , W−1].

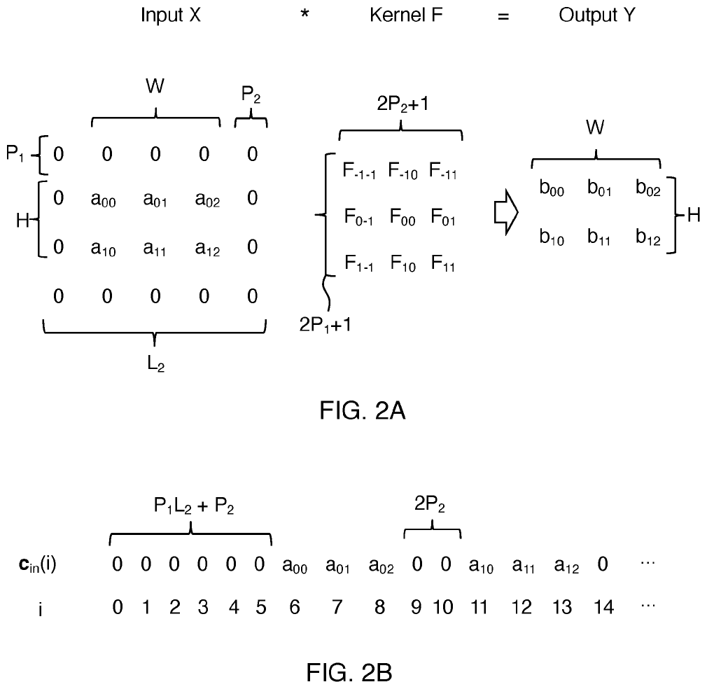

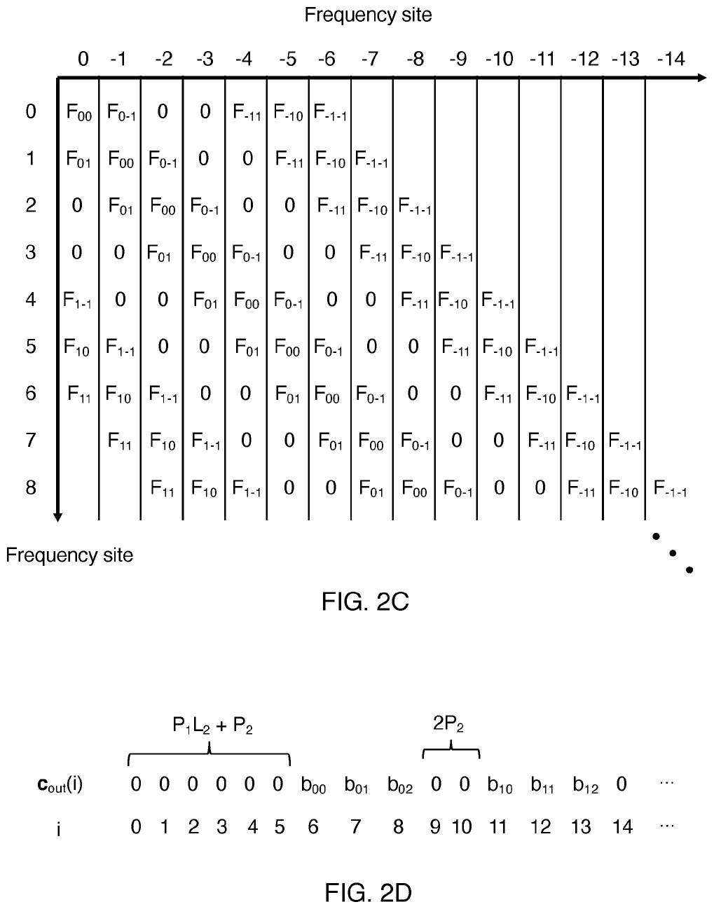

For illustration, FIG. 2A presents an example with an input A matrix of size H=2, W=3, padded with P₁=P₂=1 zero-valued elements, convolving with F matrix of size 3×3 and generating an output matrix Y of size 2×3. FIG. 2B shows the input matrix X vectorized into a 1D vector cᵢₙ as a frequency comb. FIG. 2C shows the scattering matrix generated by the modulated ring resonator maintains translational symmetry among frequency sites, which is equivalent to a convolution operation. FIG. 2D shows the output vector cₒᵤₜ after multiplication between the scattering matrix in FIG. 2C and the input vector in FIG. 2B, which recovers the convolution output matrix Y.

We now show that the 2D convolution as described by Eq. (20) can be achieved using the dynamically modulated ring resonator with the input-output relation described by Eq. (9). The input data X are flattened into the input vector cᵢₙ as given by

$${c}_{in , {iL}_{2} + j} = {X}_{i , j} , \qquad ( 21 )$$

where we choose i∈[0, . . . , L₁−1] and j∈[0, . . . , L₂−1], as shown in FIG. 2B. We also reshape the convolution kernel in Eq. (20) accordingly to the 1D kernel embedded in the scattering matrix element in Eq. (9), as

$$\begin{matrix}{s}_{- {pL}_{2} - q} & = & {F}_{- p , - q} , p ∈ \{ - {P}_{1} , … , {P}_{1} \} , q ∈ \{ - {P}_{2} , … , {P}_{2} \} , & ( 22 ) \\ & = & 0 , otherwise , & ( 23 ) \\ & & & \end{matrix}$$

as shown in FIG. 2C. The length of the converted 1D kernel is (2P₁+1) L₂+2P₂+1. Here, we note that the nonzero elements of sₘ form blocks that are not contiguous, due to the flattening of the input image into a 1D array.

From Eq. (9), and using Eqs. (21)-(23), the convolution process in the modulated ring resonator can be described as

$$\begin{matrix}{c}_{out , m} & = & {\sum }_{p = - {P}_{1}}^{{P}_{1}} {\sum }_{q = - {P}_{2}}^{{P}_{2}} {s}_{- {pL}_{2} - q} {c}_{in , m + {pL}_{2} + q} & ( 24 ) \\ & = & {\sum }_{p = - {P}_{1}}^{{P}_{1}} {\sum }_{q = - {P}_{2}}^{{P}_{2}} {F}_{- p , - q} {X}_{i + p , j + q} . & ( 25 ) \\ & & & \end{matrix}$$

By using the relation m=iL₂+j, we can map back the elements of c_{out,m} obtained from Eq. (20) with the 2D output data as

$${Y}_{i , j} = {c}_{out , m} , \qquad ( 26 )$$

as illustrated in FIG. 2D. In deriving Eq. (24), we keep only the nonzero components of s₋ₙ in the summation of Eq. (9). Therefore, we show that the 2D convolution can be achieved with a single dynamically modulated ring resonator. This process can also be generalized for higher-dimensional convolution in subsection B5.

### B3) Simulation of Two-Dimensional Convolutions

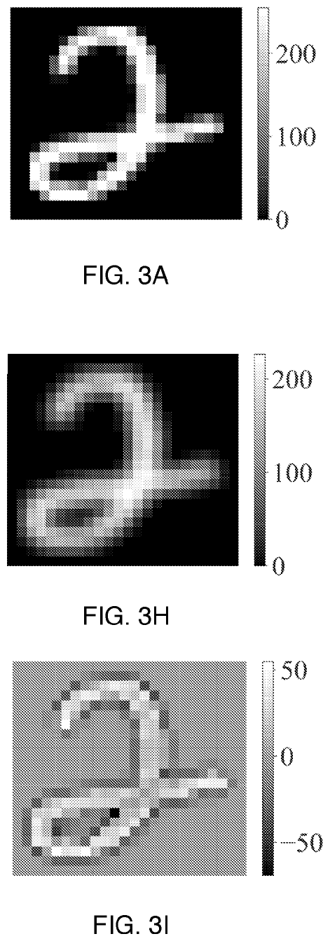

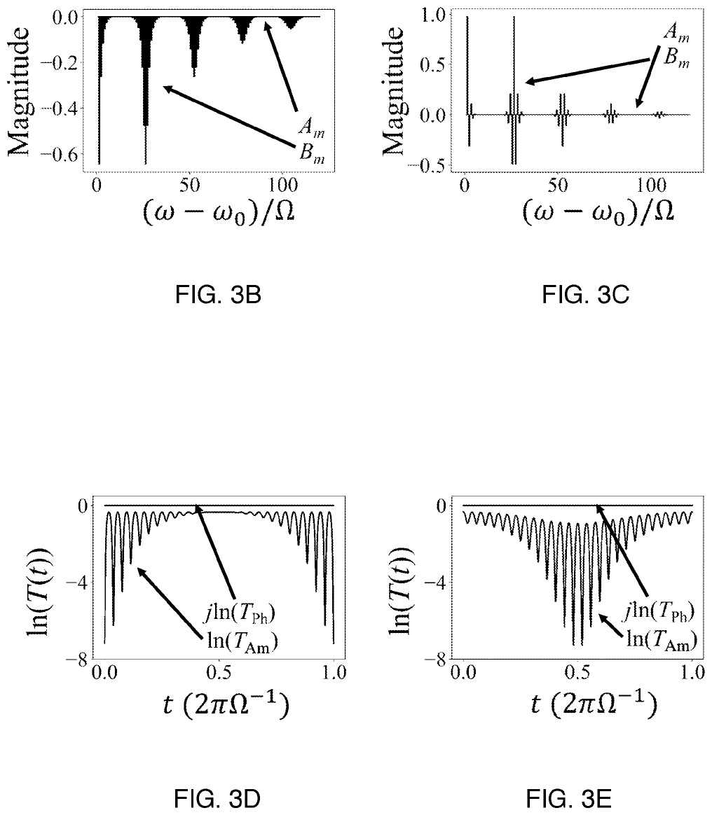

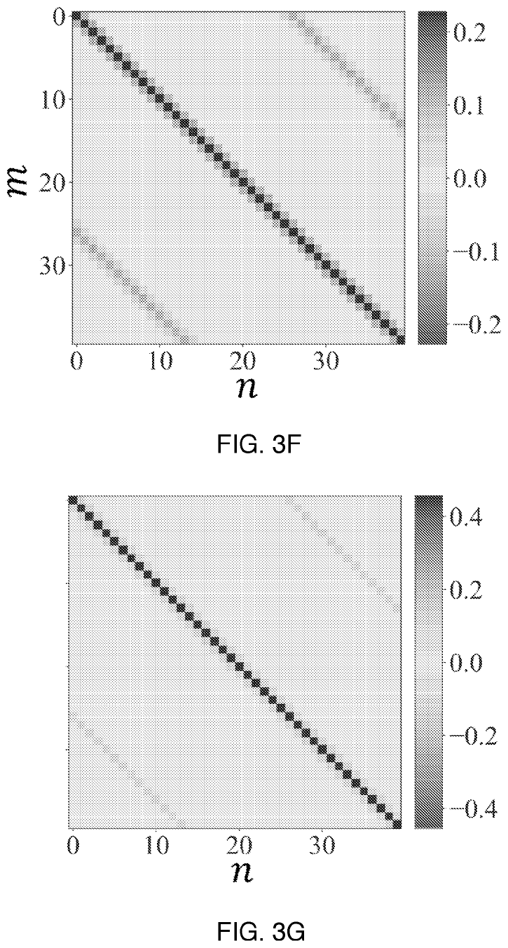

FIGS. 3A-I show a demonstration of image convolution for a symmetric Gaussian blurring kernel G and a Laplacian kernel L. FIG. 3A is the original 2D image data from MNIST representing the digit 2 with a size of 22×24. FIGS. 3B, 3C show the modulation magnitude for the phase and amplitude modulation for G and L, respectively. FIGS. 3D, 3E show the time-dependent transmission factors for G and L, respectively. Here jln(T_{Ph}) and ln(T_{Am}), the respective logarithm of transmission factors due to the phase and amplitude modulation, are plotted. FIGS. 3F, 3G schematically show the generated scattering matrices with elements S_{m,n}, which are unitless, that correspond to G and L. FIGS. 3H, 3I are the convolution output images from G and L kernels generated from the modulated ring system, where the image is blurred and highlighted with edges, respectively. In FIGS. 3A, 3H, 3I, the gray scale map represents unitless pixel values.

In this section, we employ a few kernels to show how our approach applies in 2D convolutions. The input data was a 2D image taken from the Modified National Institute of Standards and Technology (MNIST) database and cropped with central 22×24 pixels as shown in FIG. 3A. Together with padding P₁=P₂=1, the size of the input matrix X is L₁=24 and L₂=26 in the first and second dimensions, respectively. Using Eq. (21), we represent this image with a 1D input vector in the frequency space.

As the first set of examples, we consider two kernels: a Gaussian kernel G and a Laplacian kernel L:

$$G = \frac{1}{η ( G )} [ \begin{matrix}1 & 2 & 1 \\ 2 & 4 & 2 \\ 1 & 2 & 1\end{matrix} ] , L = \frac{1}{η ( L )} [ \begin{matrix}0 & - 1 & 0 \\ - 1 & 4 & - 1 \\ 0 & - 1 & 0\end{matrix} ] . \qquad ( 27 )$$

G and L are widely used in digital image processing, for image blurring and edge detection, respectively.

We follow the procedure as outlined in the previous section to implement these kernels in synthetic frequency space. For each kernel in Eq. (27), we construct the corresponding 1D kernels s using Eqs. (22) and (23). We then use Eqs. (12)-(15) to determine the appropriate modulation parameters and cavity decay rates. Since both G and L are real-valued symmetric matrices, the corresponding 1D kernels satisfy sₖ=s₋ₖ, as can be seen from Eq. (22). From Eq. (12), this implies that κₘ+κ*₋ₘ. With Eq. (13), we can see that the phase modulation has zero magnitude, i.e., Aₘ=0 for all positive integers m. Therefore, only amplitude modulation is required to implement such symmetric kernels.

Based on the previous discussion on the passivity constraint, we determine the scaling factors η(G)=17.6 and η(L)=8.78 in Eq. (27). Under this scaling factor, we obtain γ+γ₀=0.1290Ω for G and γ+γ₀=0.2125Ω for L, respectively. For m>0, we obtain the magnitude of the phase and amplitude modulation for the mth-order modulation, i.e., Aₘ and Bₘ in Eqs. (2) and (3), for G and L, as shown in FIGS. 3B and 3C, respectively, where we confirm that Aₘ=0 as expected above from the symmetry argument.

From the Aₘ and Bₘ as determined above, the time-dependent transmission factors T(t) of the modulator, as determined by Eqs. (1)-(3), are presented in FIGS. 3D and 3E for G and L, respectively, over a period of time from 0 to 2π/Ω. In this plot, and in similar plots below, we assume that γ₀=0 and plot jln(T_{Ph}) and ln(T_{Am}) using Eqs. (2) and (3). Under this temporal modulation, the frequency-domain scattering matrices for G and L are shown in FIGS. 3F and 3G, respectively. The scattering matrix is sparse. Within each row, the nonzero matrix elements are separated by zero-valued gaps, the size of which is given by the difference between the size of the kernel and input data. By multiplying this scattering matrix with the 1D input vector as generated from the image in FIG. 3A, we obtain the output images. FIG. 3H shows the output image for the Gaussian blurring kernel. We see that the output image is smoothened as compared with the input image. FIG. 3I shows the output image for the Laplacian kernel. Here, the edges of the handwritten digit are highlighted in the output images.

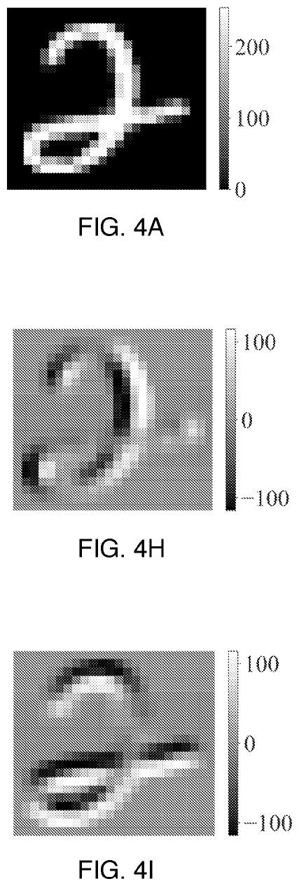

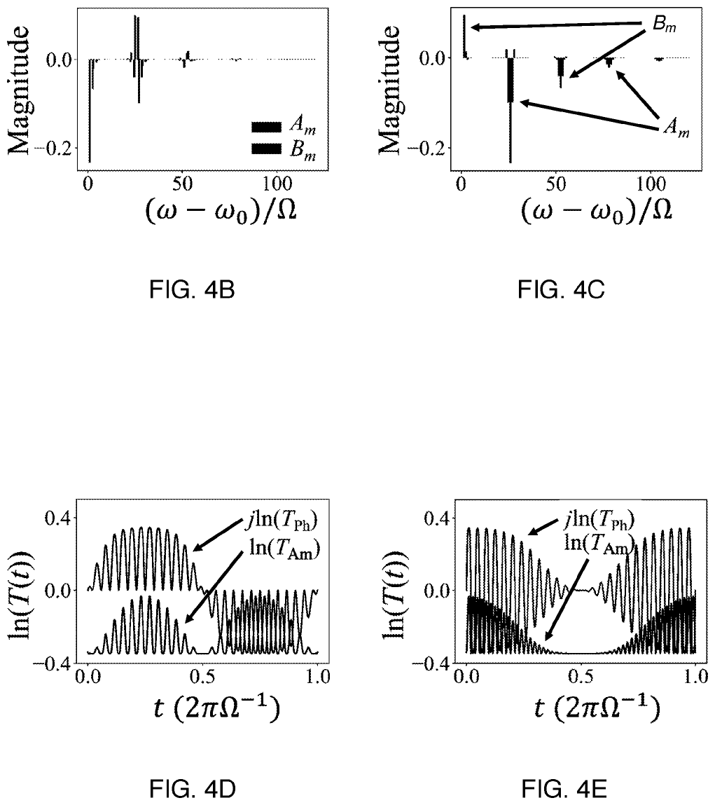

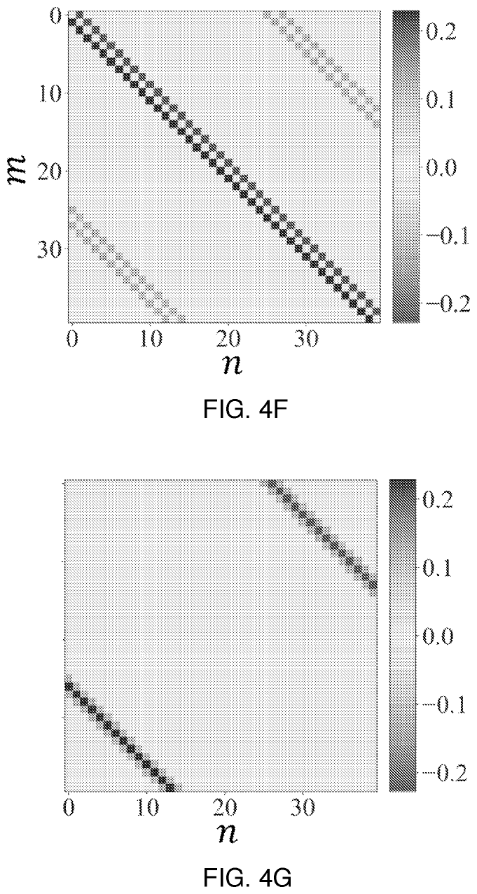

FIGS. 4A-I show a demonstration of image convolution for an asymmetric Sobel x kernel Iₓ and the Sobel y kernel I_{y}. FIG. 4A shows the original 2D image data from MNIST [the same as in FIG. 3A]. FIGS. 4B, 4C show the magnitudes for the phase and amplitude modulation of Iₓ and I_{y}, respectively. FIGS. 4D, 4E show the time-dependent transmission factors for Iₓ and I_{y}, respectively. Here jln(T_{Ph}) and ln(T_{Am}), the respective logarithms of transmission factors due to the phase and amplitude modulation, are plotted. FIGS. 4F, 4G show generated scattering matrices with elements S_{m,n}, Which are unitless, that correspond to Iₓ and I_{y}. FIGS. 4H, 4I show the convolution output images from Iₓ and I_{y} kernels generated from the modulated ring system, where the image is highlighted with the horizontal and vertical edges. In FIGS. 4A, 4H, 4I, the gray scale map represents unitless pixel values.

As a second set of examples, in FIGS. 4A-I we consider the Sobel x kernel Iₓ and the Sobel y kernel I_{y}:

$${I}_{x} = \frac{1}{η ( {I}_{x} )} [ \begin{matrix}- 1 & 0 & 1 \\ - 2 & 0 & 2 \\ - 1 & 0 & 1\end{matrix} ] , {I}_{y} = \frac{1}{η ( {I}_{y} )} [ \begin{matrix}- 1 & - 2 & - 1 \\ 0 & 0 & 0 \\ 1 & 2 & 1\end{matrix} ] . \qquad ( 28 )$$

Ix and Iy are commonly used for edge detection along the horizontal and vertical directions, respectively.

We follow the same procedure as outlined above to implement these kernels in synthetic frequency space. Iₓ and I_{y} are not symmetric matrices. To implement these matrices, both phase and amplitude modulations are required. Based on the previous discussion on the passivity constraint, we determine the scaling factors η(Iₓ)=8.7355 and η(I_{y})=8.7730 in Eq. (28). Under this scaling factor, we obtain γ+γ₀=0.04294Ω for Iₓ and γ+γ₀=0.04301Ω for I_{y}, respectively. For m>0, we obtain the magnitude of the phase and amplitude modulation for the mth-order modulation, i.e., Aₘ and Bₘ in Eqs. (2) and (3), for Iₓ and I_{y} as in FIGS. 4B and 4C, respectively. In contrast to the symmetric case, we confirm that the magnitude of the phase modulation is generally nonzero, as expected above from the symmetry argument.

From the Aₘ and Bₘ as determined above, the time-dependent transmission factors T(t) of the modulator, as determined using Eq. (1)-(3), are presented in FIGS. 4D and 4E, for Iₓ and I_{y}, respectively, over a period of time from 0 to 2π/Ω. Under this temporal modulation, the frequency-domain scattering matrices for Iₓ and I_{y} are shown in FIGS. 4F and 4G, respectively, and we observe that these matrices are sparse, similar to those shown in FIGS. 3F and 3G. By multiplying this scattering matrix with the 1D input vector as generated from the image in FIG. 4A, we obtain the output images. FIG. 4H shows the output image for the Sobel x kernel. We see that the horizontal edges of the handwritten digit are highlighted in the output image. FIG. 4I shows the output image for the Sobel y kernel. Here, the vertical edges of the handwritten digit are highlighted in the output image.

We now proceed to analyze the maximum modulation frequency required to generate a target convolution kernel. From Eq. (22), in the kernel s, among all frequency sites that have nonzero amplitudes, the maximum index of the sites corresponds to a frequency shift of

$${Ω}_{m} = ( {P}_{1} {L}_{2} + {P}_{2} ) Ω . \qquad ( 29 )$$

To generate such a kernel, the required maximum modulation frequency is typically a few times Ωₘ. As illustrations, for the examples considered in this section, Ωₘ=27Ω. As we can see in FIGS. 3B and 3C as well as in FIGS. 4B and 4C, the computed modulation magnitude becomes quite small when the order of modulation m exceeds 100. Thus, typically, the required maximum modulation frequency is about 3 to 4 times Ωₘ.

To conclude this section, we realize 2D convolution using one modulated ring resonator. Our approach should be applicable to all convolution kernels used in digital image processing.

### B4) Large-Size Image Convolution

In this section, we discuss issues associated with the limited modulation bandwidth Ω_{b} (i.e., the maximum modulation frequency) of the modulator. Again, we consider an image described by a matrix of the size H×W convolving with a kernel of the size (2P₁+1)×(2P₂+1). In our original approach as described in the previous section, we generate a padded matrix X of the size L₁×L₂, where L₁=H+2P₁, and L₂=W+2P₂. Based on the analysis in subsection B3, the required maximum modulation frequency is approximately proportional to Ωₘ as given by Eq. (29). Therefore, the required maximum modulation frequency scales linearly with one of the dimensions L₂ of the input images. Such a scaling is undesirable for large images when the modulation bandwidth is limited.

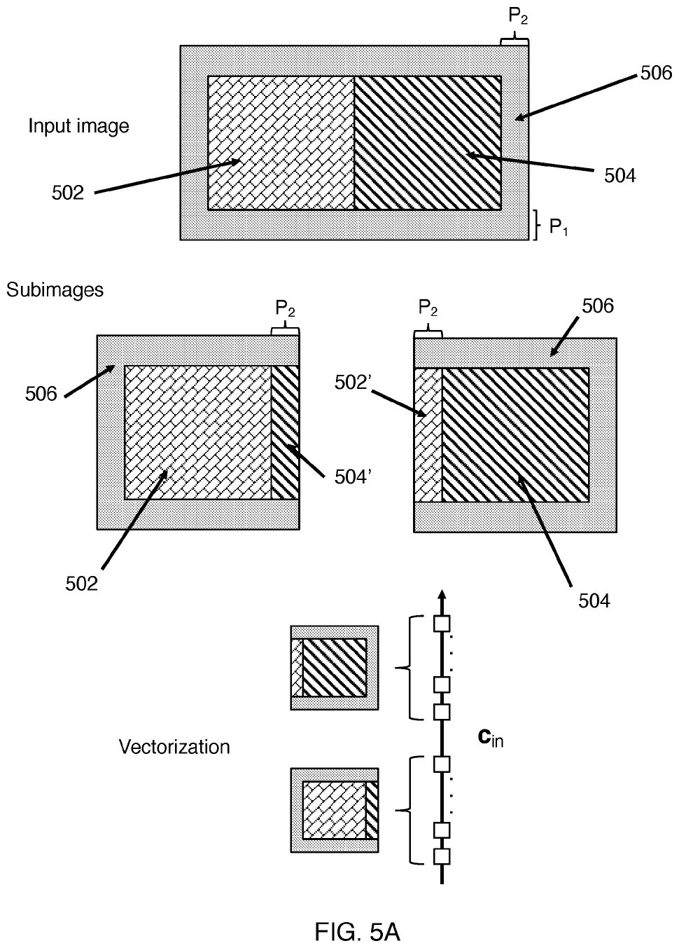

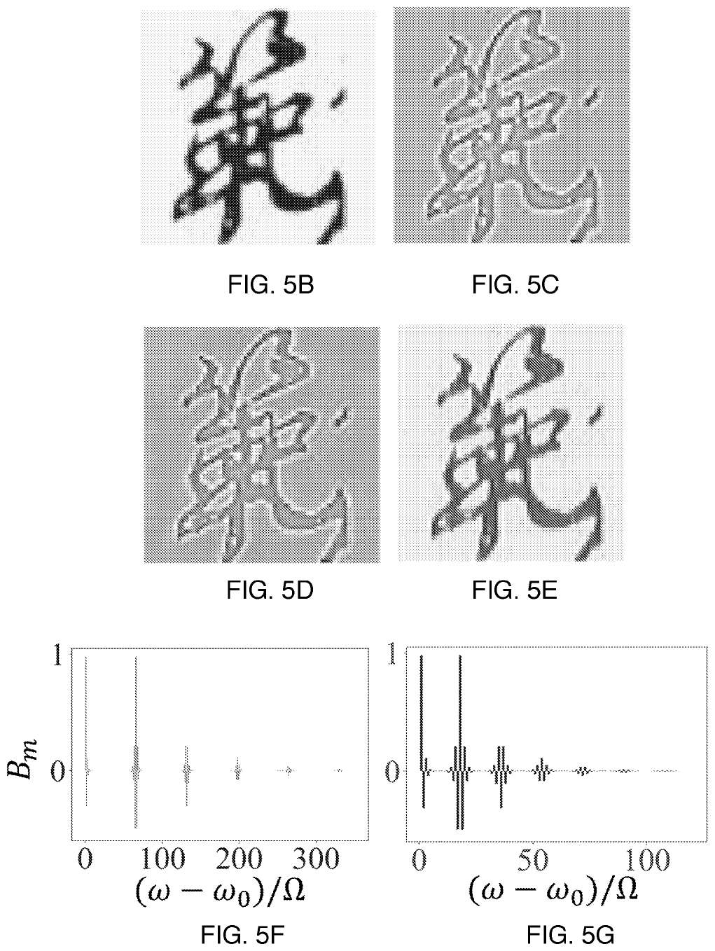

FIGS. 5A-G show a schematic for large-scale 2D convolution, where the input is sliced using the bandwidth-saving technique to efficiently utilize the modulator strength. FIG. 5A illustrates the working principles. FIG. 5B is an example input image with a size of 64×64 pixels. FIG. 5C is an output image from the original input with cutoff modulation orders at 500Ω. FIG. 5D is an output image from the sliced input as generated with cutoff modulation orders at 50Ω. FIG. 5E is an output image from the original input as generated by the modulation B_{m,o} with cutoff modulation orders at 50Ω. For FIGS. 5B-E the gray scale maps represent unitless pixel values. FIG. 5F shows the magnitudes of the amplitude modulation Bₘ required to generate the kernel using the original input. FIG. 5G shows the magnitudes of the amplitude modulation Bₘ required to generate the kernel using the sliced inputs.

Here, we provide an approach to reducing the required modulation bandwidth by judiciously slicing the image. We illustrate the working principle in FIG. 5A. We slice the image into several nonoverlapping subimages of the size H×W′ with W′<W. For each subimage, we choose a submatrix of X with the size L1×L, where L=W′+2P2, such that the subimage is located at the center of the submatrix and the padded region contains sufficient information so that the convolution operation on the subimage can be carried out. In the example of FIG. 5A, an input image having zero padding 506 is divided into two subimages 502 and 504. These subimages can be separately convolved if their padding includes information as needed from adjacent subimages. E.g., the padding for convolution of subimage 502 includes 504′ from subimage 504, and the padding for convolution of subimage 504 includes 502′ from subimage 502, as shown.

The convolution of such a submatrix with the kernel can then proceed in the same way as we have described in the previous section, with the frequency shift that corresponds to the maximum index in the kernel reduced to

$${Ω}_{m}^{′} = ( {P}_{1} L + {P}_{2} ) Ω . \qquad ( 30 )$$

Since L<L₂, Ω′ₘ<Ωₘ, and consequently the required maximum modulation frequency is also reduced. We also note that the convolution of multiple subimages can be performed in parallel. For this purpose, we form a 1D array consisting of a concatenation of all the flattened sub-matrices as described above and proceed with the same convolution operation, as shown at the bottom of FIG. 5A.

In this following, we provide an illustration. The input data was an image chosen from the Kuzushiji-Kanji data set. It is of size H=W=64, as shown in FIG. 5B. The convolution kernel is chosen as the Laplacian kernel L in Eq. (27) of size 3×3, so we have P₁=P₂=1 and L₁=L₂=66. For comparison, we represent this image with a 1D input vector in the frequency space via either the original approach as discussed in subsection B2d, with Ωₘ=67Ω given by Eq. (29), or the slicing approach, where the image is sliced into four subimages with W′=16 corresponding to Ωₘ=192 as determined using Eq. (30). For both approaches, using the method as discussed in section B2b, we obtain the magnitude Bₘ of the amplitude modulation, as shown in FIG. 5F for the original approach and in FIG. 5G for the slicing approach. For the slicing approach, Bₘ decreases more rapidly as m increases, as compared with the original approach. For both cases, we also confirm that Aₘ=0, which is consistent with the previous observation.

We now show that the slicing approach can produce the desired output but with lower requirements on the modulation bandwidth. FIG. 5C shows the output image with the original approach, with a maximum modulation frequency of 500Ω. FIG. 5D shows the output image with the slicing approach, with a maximum modulation frequency of 50Ω. We see that the output images in FIGS. 5C and 5D are very similar to each other, as both highlight the edges of the input image. In contrast, in FIG. 5E, we show the output image with the original approach but with a maximum modulation frequency of 50Ω. The output image resembles the original image and no longer highlights the edges. Our results indicate that the slicing approach can indeed significantly reduce the requirement on the modulation bandwidth as compared with the original approach.

### B5) Higher-Dimensional Convolution

In the above discussions, we consider 2D convolution, which is useful for extracting spatial features within a single 2D image. However, many applications produce higher-dimensional input data sets. For example, LIDAR scans produce an array of images at various spatial depths and a video includes an array of images at different temporal frames. For processing these data sets, higher-dimensional convolution is important. For processing of LIDAR data sets, 3D convolution is useful in identifying 3D objects. For video processing, 3D convolution is useful in recognizing and predicting motion. Thus there have been emerging interests in creating specialized hardware for such computations.

Higher-dimensional convolutions are more computationally demanding as compared with 2D convolutions. Here, we show that higher-dimensional convolutions can be accomplished using the same modulated ring cavity as we have discussed above. Our approach for higher-dimensional convolution closely follows that of the 2D case. Here, as an illustration, we consider the 3D case. The input data are represented by a matrix of size H×W×D. The kernel matrix F is of the size (2P₁+1)×(2P₂+1)×(2P₃+1). We again generate an input matrix X by padding the input data along three dimensions so that the convolution output has the same dimension as the input. The resulting input matrix X has dimensions of L₁×L₂×L₃, where L₁=H+2P₁, L₂=W+2P₂, and L₃=D+2P₃. For i=[0, 1, . . . , H−1], j=[0, 1, . . . , W−1], and k=[0, 1, . . . , D−1], the 3D convolution can be described by

$${Y}_{i , j , k} = {\sum }_{p = - {P}_{1}}^{{P}_{1}} {\sum }_{q = - {P}_{2}}^{{P}_{2}} {\sum }_{t = - {P}_{3}}^{{P}_{3}} {F}_{- p , - q , - t} {X}_{i + p , j + q , k + t} . \qquad ( 31 )$$

To implement such a 3D convolution in the synthetic dimension, we form a 1D vector as

$${c}_{in , {iL}_{3} {L}_{2} + {jL}_{3} + k} = {X}_{i , j , k} . \qquad ( 32 )$$

We also map the convolution kernel in Eq. (31) to the scattering matrix element in Eq. (9) as

$${s}_{- {pL}_{3} {L}_{2} - {qL}_{3} - t} = {F}_{- p , - q , - t} , \{ p , q , t \} ∈ \{ [ - {P}_{1 , 2 , 3} , ⋯ , {P}_{1 , 2 , 3} ] \} , \qquad ( 33 )$$

$$= 0 , otherwise , \qquad ( 34 )$$

In this way, we can achieve the 3D convolution output as

$${c}_{out , m} = {\sum }_{p = - {P}_{1}}^{{P}_{1}} {\sum }_{q = - {P}_{2}}^{{P}_{2}} {\sum }_{t = - {P}_{3}}^{{P}_{3}} {s}_{- {pL}_{3} {L}_{2} - {qL}_{3} - t} {c}_{in , m + {pL}_{3} {L}_{2} + {qL}_{3} + t} \qquad ( 35 )$$

$$= {\sum }_{p = - {P}_{1}}^{{P}_{1}} {\sum }_{q = - {P}_{2}}^{{P}_{2}} {\sum }_{t = - {P}_{3}}^{{P}_{3}} {F}_{- p , - q , - t} {X}_{i + p , j + q , k + t} . \qquad ( 36 )$$

By choosing m=iL₃L₂+jL₃+k, we recover Y_{i,j,k}=c_{out,m}. The required modulation amplitudes and cavity decay rates can be determined from the kernel s in the same way as discussed above.

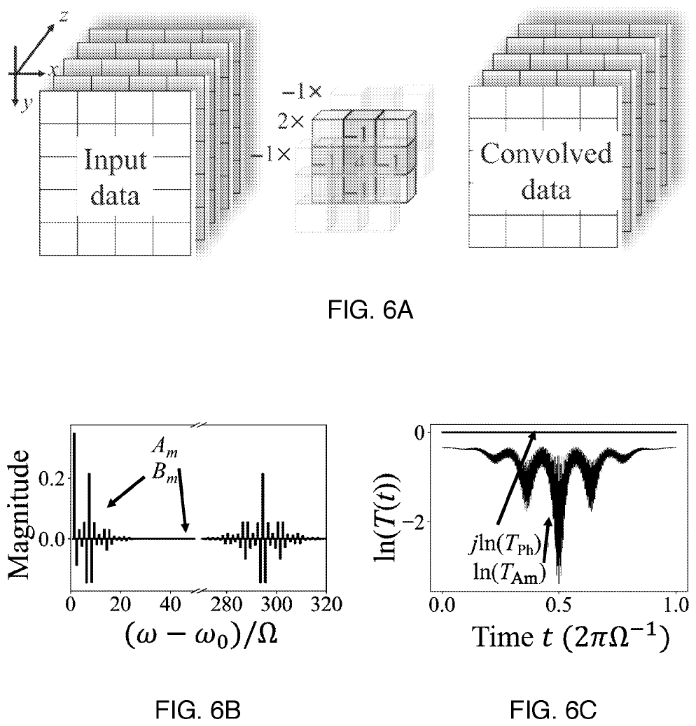

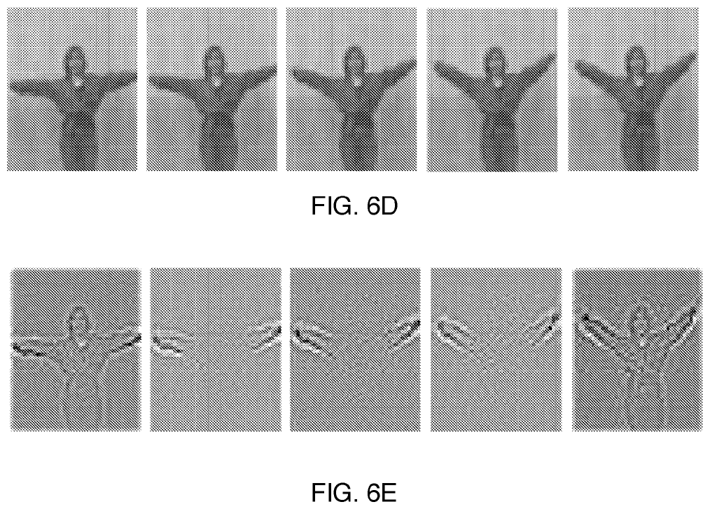

FIG. 6A is a schematic for multidimensional convolution, where the input has multiple channels. FIG. 6B show the modulation magnitude to generate the 3D Laplacian kernel. FIG. 6C shows the time-dependent transmission factors, jln(T_{Ph}) and ln(T_{Am}), due to the phase and amplitude modulation. FIG. 6D shows input data having an array of images at different temporal frames to represent a person waving his or her arms. FIG. 6E show the output convolution image, having an array of images at different temporal frames that highlight the arm motion. In FIGS. 6D, 6E, the gray scale maps represent unitless pixel values.

As illustrated in FIG. 6A, we present an example with the input as an array of image frames from a human-motion-recognition database that describe a person waving both arms upward. The total input is cropped to size 50×40×5 FIG. 6D and includes five images of the size 50×40 at five different times. We implement a convolution kernel that corresponds to an operator

$${\partial }_{t}^{2} ( {\partial }_{x}^{2} + {\partial }_{y}^{2} ) ,$$

where t and x, y correspond to the time and the two spatial dimensions in the input, respectively. This operator is chosen to highlight the motion of the edge of an object. Using a finite-difference approximation, this operator is implemented as a 3×3×3 kernel matrix \tilde{L}, with three temporal planes denoted as \tilde{L}_{1,2,3}, which are given by

$${\tilde{L}}_{1} = [ \begin{matrix}0 & 1 & 0 \\ 1 & - 4 & 1 \\ 0 & 1 & 0\end{matrix} ] , \qquad ( 37 )$$

$${\tilde{L}}_{2} = [ \begin{matrix}0 & - 2 & 0 \\ - 2 & 8 & - 2 \\ 0 & - 2 & 0\end{matrix} ] ,$$

$${\tilde{L}}_{3} = {\tilde{L}}_{1} .$$

For this kernel (\tilde{L}), the scaling factor is chosen as η(\tilde{L})=1.2η=37.736, where we use a slightly larger scaling factor compared with Eq. (18) due to the high-bandwidth modulation for the 3D convolution. The corresponding γ+γ₀=0.10. The modulation profile for generating the convolution kernel given by Eq. (22) is shown in FIG. 6B. In general, 3D convolution requires a higher modulation bandwidth as compared with 2D convolution. Here, for simplicity, we use the original approach in section B2d but the modulation bandwidth can also be reduced with the slicing approach as discussed in section B4.

For the modulation thus determined, the time-dependent transmission factors for the amplitude and phase modulations are shown in FIG. 6C. We note that the phase modulation is constantly zero, similar to the 2D case. Compared with the 2D case as shown in FIGS. 4D and 4E, the difference between the largest and smallest modulation frequencies is significantly larger. We show in FIG. 6D five input-video clipped images arranged in temporal order. The input images show a person waving his or her arms upward, whereas the other parts of the body remain still. Using the convolution kernel shown in Eq. (37), the 3D convolution is expected to detect the motion of arms and highlight the edges. As shown in FIG. 6E, the output images from convolution with the ring resonator are arranged in the same temporal order as the input. Similar to the 2D convolution case, the first and last frames of the output images highlight the outlines of the person as expected. However, as shown from the second to the fourth frame of the output, the 3D convolution provides additional information that is useful for recognizing human motion. We observe in the central three frames that only the arms are highlighted, whereas the other parts of the person have negligible signals, which indicates that the person is moving his or her arms in the video.

To summarize this section, we show that 3D convolution can be realized in a single dynamically modulated optical ring resonator. The higher-dimensional convolution introduced here has broad applications, such as 3D convolution for edge feature extraction and scene reconstruction, four-dimensional (4D) convolution for spatiotemporal detection, as well as six-dimensional (6D) convolution for noise-robust geometric pattern recognition.

### B6) Conclusions

We describe a scheme for realizing arbitrary convolution kernels in synthetic frequency space using a simple setup with one ring resonator incorporating one phase and one amplitude modulator. This scheme can be used to perform multidimensional convolutions. We provide an analytic approach that determines the required modulation profile for any convolution kernel. In our scheme, the dimension of the input data set that can be processed is limited by the number of equally spaced frequency modes available in the ring, as well as by the loss of the ring. The number of such equally spaced modes is controlled by the group-velocity dispersion of the waveguide forming the ring and the loss may be compensated with the use of an amplifier. Experimentally, nearly one thousand equally spaced frequency modes have been observed in on-chip systems. The group-velocity dispersion in this lithium niobate (LN) system is estimated to be β₂=−50 ps²/km and n≈2. Assuming the FSR as 1 GHz, the circumference of the ring is related by [symbol] =c/n/FSR=0.15 m. The shift in the FSR is then given by ΔFSR=−2π [symbol] (FSR)³β₂=47.1 Hz. Hence, even in the presence of group-velocity dispersion, nearly one thousand frequency modes are equally spaced within the line width of the resonant modes of the ring. A larger number of modes may be achievable in another fiber-ring reported on in the literature.

This convolution processing in the synthetic dimension can be implemented for both fiber-loop and on-chip platforms, where a sufficiently fast modulation speed compared to the FSR has been demonstrated. Future advances in the fabrication of high-speed and high-confinement modulators, as well as high-speed photodetectors, may reduce the required energy consumption.

The results demonstrated here can also be extended to complex-valued convolutional neural networks, which have been successfully applied in computer vision, especially in processing magnetic-resonance-imaging data, which are complex in their raw form, with the advantages of avoiding overfitting and of robustness to noise. Other than frequency, we anticipate that this convolution scheme can be applied to other internal degrees of freedom of the photon, such as spin, linear momentum, and optical angular momentum. Similar ideas may also be implemented in Rydberg-atom systems. For the realization of convolution, there must be no boundary in the frequency range where the convolution is performed. This requirement is different from the requirement in performing arbitrary finite-dimensional linear transformation as discussed in Buddhiraju et al. (cited above), where a boundary is required and can be achieved with the use of auxiliary rings. Such a boundary in frequency dimension has been recently demonstrated in the literature. Our approach to convolution processing points to a direction for removing the computing bottleneck in traditional electronic circuits and may be useful in improving machine-learning hardware for artificial-intelligence applications.

### C) Experiment

### C1) Introduction

In this section, we experimentally demonstrate the use of a synthetic frequency dimension as formed by a dynamically modulated ring resonator to enable convolution operation. Specifically, we synthesize a wide range of convolution kernels with pre-determined modulation waveforms. We achieve various intended convolution kernels with good agreement with theory. We also demonstrate the convolution computation by generating different frequency-mode inputs. The output frequency comb obtained from the ring agrees well with the target output as processed by convolution. We also introduce a pathway to broaden the kinds of kernels that can be implemented experimentally when the modulation strength is limited.

The concept of synthetic frequency dimension has been previously employed to demonstrate topological physics and matrix-vector multiplication. But the use of synthetic frequency dimension for convolution has not been demonstrated experimentally. Frequency combs have been previously used for optical convolution purposes, but this prior work does not utilize the dynamics of light along the frequency dimension, i.e., these works do not utilize the possibility of frequency mixing and conversion as offered by a dynamically modulated system, which is at the heart of the concept of synthetic frequency dimension. Our work introduces a new physics mechanism for achieving optical convolution and is important for the quest to achieve large-scale parallel optical computation with compact devices.

### C2) Modulation Waveform Design

FIG. 7 is a schematic illustration of the experimental setup, where the convolution operation is performed by a ring resonator 104 modulated by an electro-optical amplitude modulator 106. The modulation has its frequency components located at the free-spectral range Ω_{R} of the ring as well as its integer multiples. An input optical frequency comb is injected into the modulated ring resonator from waveguide 702. The output frequency comb is detected at the drop-port optical waveguide 704.

Assuming that the ring resonator and waveguides all support a single mode, and the group velocity dispersion is negligible, Ω_{R}=2πc/n_{g}l corresponds to the free spectral range (FSR) of the ring resonator. Here c, n_{g} and l represent light speed, group refractive index, and ring circumference, respectively. t_{R}=2π/Ω_{R} denotes the round-trip time of the ring. Specifically, here we consider the case that the modulator exclusively modulates in the amplitude of light, which can be described by the temporal transmission factor:

$${T}_{Am} ( r ) = exp [ {\sum }_{m \geq 1} {B}_{m} sin ( m {Ω}_{R} t + {β}_{m} ) - γ {t}_{R} ] . \qquad ( 37 )$$

Bₘ and βₘ correspond to the magnitude and phase angle of the waveforms in the amplitude modulators for the m-th order resonant modulation component, respectively. γ corresponds to time-averaged loss as induced by the amplitude modulator. In using Eq. (37) to describe a passive amplitude modulator that has no gain, γ is positive and needs to be sufficiently large so that T_{Am}(t)<1 for all t. The ring resonator is coupled to an input and an output waveguide. Since T_{Am}(t)=T_{Am}(t+t_{R}), the frequency components of the modulation waveform are located at integer multiples of the FSR of the ring resonator. Therefore, with modulations, the resonant modes of the ring at different frequencies can resonantly couple with each other.

In FIG. 7, there is an input waveguide 702 that couples to the ring with a coupling coefficient γₑ₁, as well as a drop-port waveguide 704 coupling to the ring resonator with a coupling coefficient γₑ₂. The output frequency comb from this drop-port waveguide corresponds to cₒᵤₜ. The modulation waveform as described above can be used to implement a convolution kernel in the frequency dimension. The ring resonator supports N equally spaced resonant modes with frequencies ωₙ=ω₀+nΩ_{R}, 1≤n≤N, with ω₀ corresponding to the central resonant frequency. We assume an input wave with a form cᵢₙ=Σₙc_{in,n}exp[jωₙt+jΔωτ], with Δω being the detuning. The wave inside the modulated ring then has the form a(t)=Σₙaₙ(t)exp[jωₙt+jΔωτ]. The modal amplitudes aₙ's can be determined by the temporal coupled-mode theory. Defining the input and output wave amplitude vectors cᵢₙ=[ . . . , c_{in,n}, . . . ] and cₒᵤₜ=[ . . . , c_{out,n}, . . . ], we obtain the scattering matrix that connects cᵢₙ and cₒᵤₜ by cₒᵤₜ=Scᵢₙ, and S is given by,

$$S = j 2 {γ}_{e 1} {γ}_{e 2} {\{ K + [ j ( γ + {γ}_{cst} ) - Δ ω ] I \}}^{- 1} . \qquad ( 38 )$$

Here, γ_{cst} is the total rate of loss in the resonator from mechanisms other than the amplitude modulator. These mechanisms can include, for example, the propagation loss of light in the fiber, as well as input and output coupling, as characterized by the input and output coupling rate of γₑ₁ and γₑ₂, respectively. Here we assume that such a loss rate is the same for every resonant mode in the system. I is an identity matrix. The matrix elements of K satisfy the translational symmetry, i.e. K_{m,n}=κₘ₋ₙ, where m and n are the indices of the modes. κ_{±p}, with p>0, is the coupling constant between two modes m and n satisfying |m−n|=p, and is related to the modulation parameters by

$${κ}_{\pm p} = \pm \frac{1}{2 {t}_{R}} {B}_{p} exp ( \pm j {β}_{p} ) .$$

To simplify the representation, we denote κ₀=j(γ+γ_{cst})−Δω to combine the loss and detuning factors into K matrix. S, consequently, is a matrix with elements S_{m,n}=sₘ₋ₙ so it has a translational symmetry along the frequency axis.

Due to the translational symmetry along the frequency axis, the scattering matrix in Eq. (38) implements a one-dimensional convolution operation,

$${c}_{out , m} = {\sum }_{n} {S}_{m , n} {c}_{in , n} = {\sum }_{n} {s}_{m - n} {c}_{in , n} = {\sum }_{n} {s}_{n} {c}_{in , m - n} . \qquad ( 39 )$$

Here sₙ is the n-th element of a kernel for the convolution operation. In this work, we often represent a kernel as a row vector with an odd number of elements.

For experimental design, it would be desirable to generate a prescribed kernel with an analytical modulation waveform. Assuming zero detuning, Δω=0, for a given kernel with elements sₙ's, the corresponding modulation parameters Bₘ and βₘ are given by,

$${B}_{m} exp ( j {β}_{m} ) = {t}_{R} ( {κ}_{+ m} - {κ}_{- m}^{*} ) , \qquad ( 40 )$$

$$γ + {γ}_{cst} = - j {κ}_{0} , \qquad ( 41 )$$

where coupling constants κₘ are related to the kernel elements sₙ's via

$${κ}_{m} = \frac{j {γ}_{e 1} {γ}_{e 2}}{π} {\int }_{0}^{2 π} \frac{exp ( - jmk )}{{\sum }_{n} {s}_{n} exp ( jnk )} dk . \qquad ( 42 )$$

### C3) Experiment

### C3a) Kernel Synthesis Experiment

Our experiments use a fiber ring resonator modulated by an electro-optic modulator as shown in FIG. 7. The ring has a free spectral range of Ω_{R}=2.5.99 MHz, corresponding to a circumference of l=34.3 m. From the input waveguide, we launch a continuous wave (CW) laser into the ring resonator through a fiber coupler. The laser's frequency is scanned across a resonance of the unmodulated ring. Within the cavity, we use an Er-doped fiber amplifier (EDFA) to compensate for part of the roundtrip loss. At each detuning Δω, we measure the time-resolved output power I(Δω,t) at the drop port, using a fast photodiode with a bandwidth over 5 GHz and an oscilloscope of 1 GHz analog bandwidth.

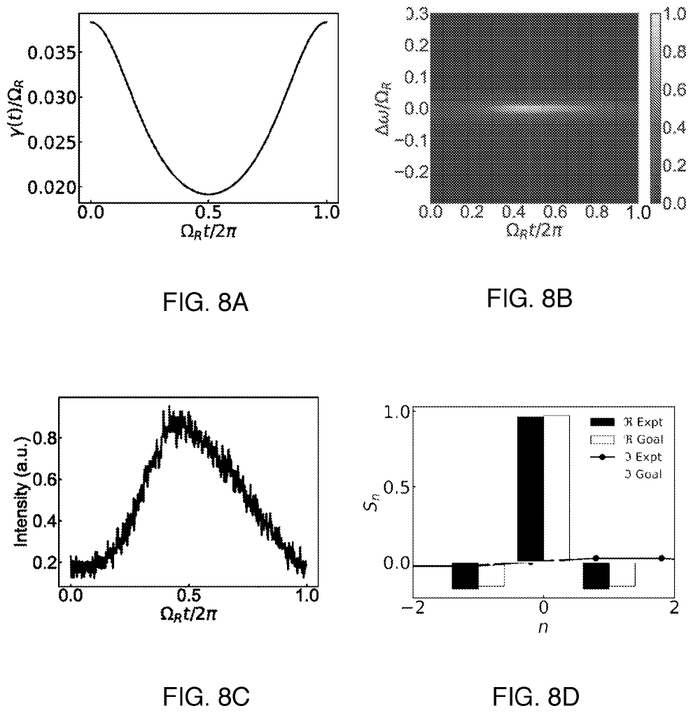

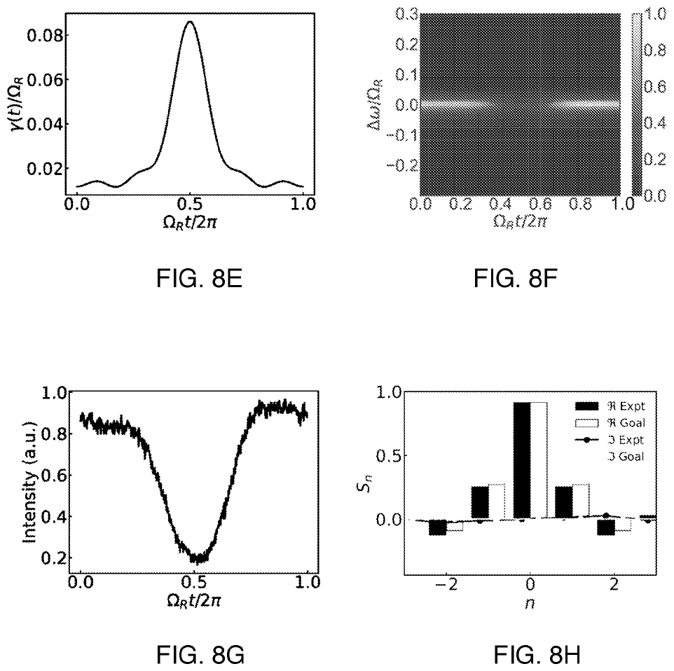

FIGS. 8A-H relate to experimental synthesis of convolution kernels. A high-boost kernel [−1, 6, −1] is used in FIGS. 8A-8D and a Laplacian of Gaussian kernel [−1, 3, 10, 3, −1] is used in FIGS. 8E-8H. FIGS. 8A and 8E show calculated instantaneous loss rate γ(t) as a function of time in a roundtrip. FIGS. 8B and 8F show measured time- and frequency-detuning-resolved output intensity I(Δω,t). This is measured at the drop port from a dynamically modulated ring resonator. FIGS. 8C and 8G show measured I(Δω, 0) in FIGS. 8B and 8F, respectively. FIGS. 8D and 8H show a comparison of the synthesized kernel and target kernel. The black bar/line corresponds to the real/imaginary part of the experimental kernel. The white bar/line corresponds to the real/imaginary parts of the target kernel.

We experimentally construct various convolution kernels based on the theory as discussed above. Here the setup is launch of a single frequency and therefore the output manifests the kernel. In the first example (FIGS. 8A-8D), we demonstrate the high boost kernel, which has three nonzero elements of s₀=6 and s_{±1}=−1. This kernel is widely applied in image processing to sharpen the high-frequency edge information and enhance the low-frequency feature information in the image.

To generate this kernel, we first calibrate the loss rate γ+γ_{cst}=0.027Ω_{R}. This calibration is described in more detail below. With this γ+γ_{cst} and Eqs. (40)-(41), we obtain the modulation waveform. For the amplitude modulation as described by Eq. (37), the magnitudes are: B₁=5.858×10⁻², B₂=9.994×10⁻³, B₂=1.679×10⁻³, B₄=2.676×10⁻⁴, and B₅=3.323×10⁻⁵, the phase angles are β₁=1.576, β₂=1.580, β₃=1.585, β₄=1.590, β₅=1.594. At any given time, the instantaneous loss rate of the cavity is defined as

$$γ ( t ) = γ + {γ}_{cst} + {\sum }_{m \geq 1} \frac{{B}_{m}}{{t}_{R}} cos ( m {Ω}_{R} t ) . \qquad ( 43 )$$

γ(t) is above zero as shown in FIG. 8A. Therefore, the modulation as designed in this way satisfies the passivity constraint and the system is always dissipative.

We apply the modulation waveform, as designed above, to the ring resonator. In the experiment, we vary the detuning Δω by adjusting the input laser frequency. At each detuning Δω, we record the intensity at the drop port I(Δω,t) as a function of time. The resulting 2D plot of I(Δω,t) is plotted in FIG. 8B. We observe that the linewidth of the resonance is the smallest at about t=π/Ω_{R} in the horizontal axis defined in FIG. 8B. This is consistent with FIG. 8A, where the instantaneous loss rate is lowest at the same t.

To determine the kernel from the output intensity measurement I(Δω,t), we recall that I(Δω,t)=|S(Δω,t)|², with S(Δω,t) being the time-domain scattering factor of Eq. (38). Since the modulation in FIG. 8A is designed for the kernel at Δω=0, we plot I(Δω=0,t) as shown in FIG. 8C. Throughout this section, all the kernel generation and convolution are based on this Δω=0 line only. As the high-boost kernel demonstrated here is real-valued and symmetric, the time-domain scattering factor S(0,t)=Σₙsₙexp(jnΩ_{R}t) should be real-valued as well, with sₙ defined in Eq. (39). We have used an example single cosine modulation to prove that the modulation waveform only results in a change of γ(t) in Eq. (42). We confirm that the amplitude modulation waveform that is obtained from the experiment agrees well with what is implemented on the modulator. This proves that S(0,t) purely results from amplitude modulation, so S(0,t) is real-valued, and the phase variation in a round-trip is negligible. From I(0,t) as shown in FIG. 8C and I(0,t)=|S(0,t)|², we obtain S(0,t)=\sqrt{I(0,t)}. We then perform a Fourier transform of S(0,t) to determine the kernel sₙ that is obtained in the experiment.

In FIG. 8D, we compare the kernel obtained from experiments and target designs. The sₙ from the experimental measurement is shown next to the sₙ from the target design. Both kernels are normalized such that Σn|sₙ|²=1. These two kernels agree well and verify that the high-boost kernel is synthesized successfully.

As one more example of kernel synthesis, in FIGS. 8E-8H we synthesize a quantized Laplacian of Gaussian kernel with its non-zero elements being s₀=10, s_{±1}=3, s_{±1}=−1. This quantized kernel is suitable for compressing features and tracking the machine-learning process. The modulation waveform is designed in a similar way as above using Eqs. (40)-(41). The magnitudes of the modulation waveform are B₁=0.1539, B₂=0.1014, B₃=0.05854, B₄=0.03525, B₅=0.02094. The corresponding phase angles are, β₁=−1.566, β₂=1.580, β₃=−1.557, β₄=1.590, β₅=−1.547. Using these parameters, the instantaneous loss rate given by Eq. (42) is plotted in FIG. 8E. Contrary to the prior example, the instantaneous loss rate is highest in the middle of the roundtrip in this case. In FIG. 8F, we present the measured time and frequency detuning resolved output intensity I(Δω,t). I(Δω=0,t) is plotted in FIG. 8G. Using a similar method as in the previous example, we extract the experimental kernel sₙ's from I(Δω=0,t). As shown in FIG. 8H, the experimental kernel agrees well with the target kernel, which verifies that our analytically designed modulation waveform can faithfully synthesize a multi-element quantized Laplacian of Gaussian kernel.

### C3b) Convolution Kernel Construction with an Additive Offset

As seen in the two examples provided in the previous section, the implemented kernel typically has a strong so component in our modulated ring setup. This arises because of the high internal loss factor γ_{cst} and the limited lithium niobate modulator strength. In this section, we implement the convolution kernel with an additive offset, as described in the form of:

$${c}_{out , n} = {bc}_{in , n} + {\sum }_{m} {s}_{n - m} {c}_{in , m} , \qquad ( 44 )$$

where b<0 is the additive offset. Alternatively, we consider the implementations of Eq. (44) in order to broaden the kinds of kernels that can be implemented in a fiber experimental system.

In our setup, the operation of Eq. (44) can be implemented by synthesizing a kernel {\tilde{s}ₙ} where \tilde{s}₀=s₀+b and \tilde{s}ₙ=sₙ for n≠0, in the same way as we described in the previous Section.

We note that Eq. (44) can be implemented all-optically. In this all-optical implementation, one passes the input light through a beam splitter to separate it into two paths. In the first path, one implements the operation of the first term in Eq. (44) using a m phase shifter and an attenuator or amplifier. In the second path, one implements the second term in Eq. (44) using our modulated fiber ring setup. The transmitted lights from these two paths are then combined to realize Eq. (44). A schematic of this realization is described below.

Here, as an illustration of Eq. (44) and for simplicity, instead of the all-optical implementation as discussed above, we present results from a hybrid implementation. In the hybrid implementation, for a prescribed target kernel \tilde{s}ₙ, we separate it into two terms in Eq. (44) such that the second term can be implemented using our modulated ring setup. We then present the end results assuming that the first term and the summation operation in Eq. (44) have been carried out digitally.

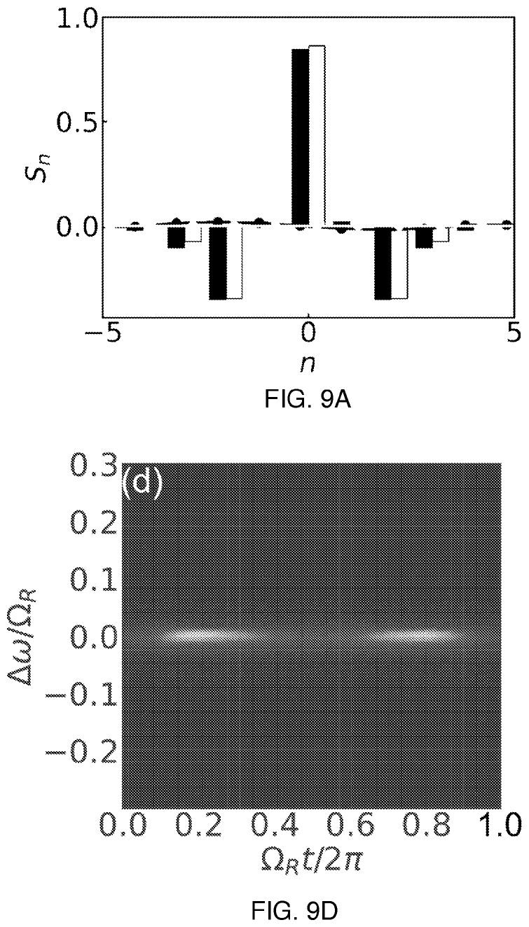

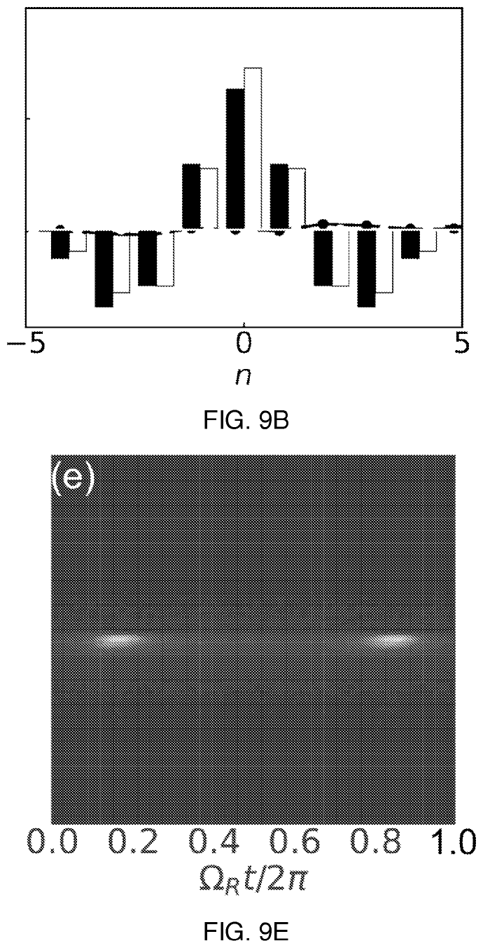

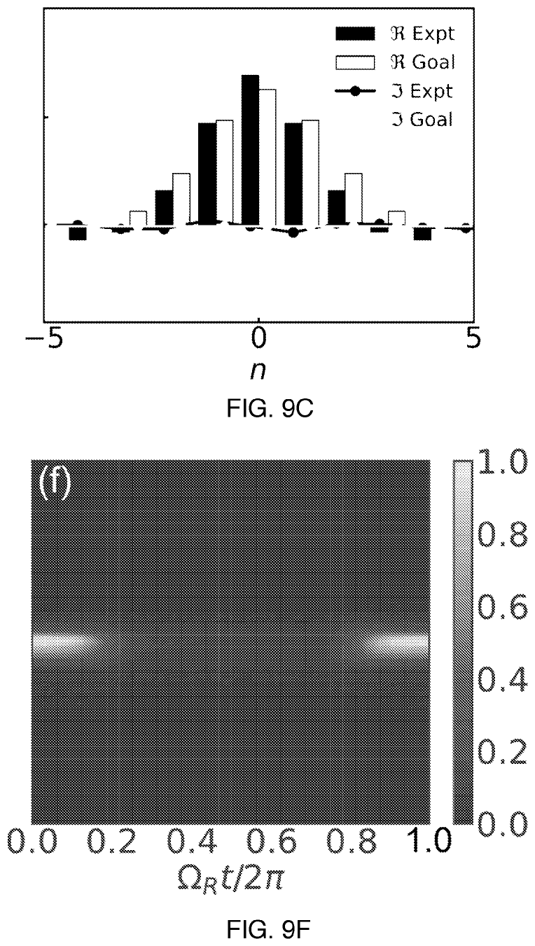

FIGS. 9A-F show construction of convolution kernels with multiple examples of various kernels. FIGS. 9A, 9D relate to a standard Laplacian of Gaussian kernel [−1, −4.56, 0.028, 11.304, 0.028, −4.56, −1] with b=20, FIGS. 9B, 9E relate to a another standard Laplacian of Gaussian kernel [−1, −2.9, −2.6, 2.8, 7.4, 2.8, −2.6, −2.9, −1] with b=20, FIGS. 9C, 9F relate to a Gaussian kernel [1, 3.5, 7, 9, 7, 3.5, 1] with b=8. The upper panels (FIGS. 9A, 9B, 9C) correspond to the synthesized kernel measured (in black) and target (in white) kernels with the real and imaginary parts plotted in bar and lines respectively. The lower panels (FIGS. 9D, 9E, 9F) correspond to the time- and frequency-detuning-resolved output intensity measurements. The experimentally synthesized kernel in FIGS. 9A, 9B, 9C is obtained from FIGS. 9D, 9E, 9F, respectively.

In FIGS. 9A-H, we present the implementations of various kernels using this hybrid approach. Both FIGS. 9A and 9B demonstrate a standard Laplacian of Gaussian kernel with different parameters. In both cases, the kernel elements are summed to zero. This Laplacian of Gaussian kernel is widely applied in noise-robust spatial filtering and edge detection. FIG. 9A corresponds to a seven-element kernel with a standard deviation σ=1.0. FIG. 9B corresponds to a nine-element kernel with a standard deviation σ=1.4. FIG. 9C presents a Gaussian kernel with a standard deviation σ=1.4. Such a Gaussian kernel is useful for suppressing high-frequency noise in a limited spatial spread area, which is essential for digital telecommunications.

FIGS. 9D-9F correspond to the time- and frequency-detuning-resolved output intensity measurement. The experimentally synthesized kernel in FIGS. 9A-9C is obtained from FIGS. 9D-9F, respectively, using the same method discussed in the previous Section. All of the kernels are normalized such that Σₙ|sₙ|²=1. In FIG. 9A to FIG. 9C, the measured kernels agree very well with the target kernels in both real and imaginary parts. This verifies that we can synthesize a broad range of kernels at high accuracy with the approach as described by Eq. (44).

### C3c) Convolution Processing

In the previous sections, we demonstrated the synthesis of several convolution kernels. In these demonstrations, we performed convolution operations with an input vector that had only a single element. In this section, we provide an experimental demonstration of the convolution operation of the kernels with various input vectors that have multiple frequency comb lines.

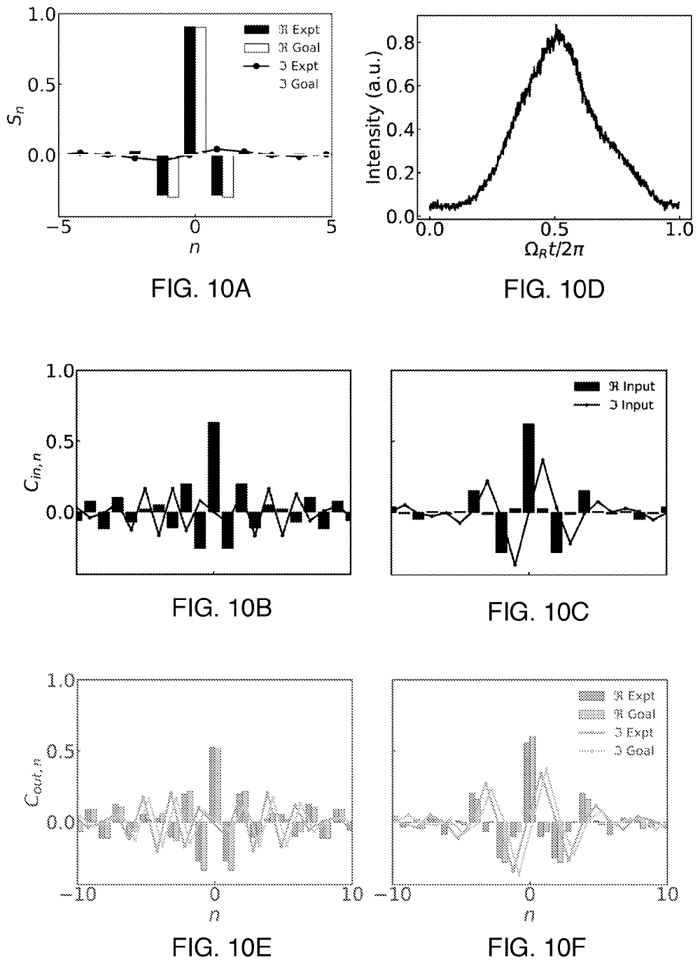

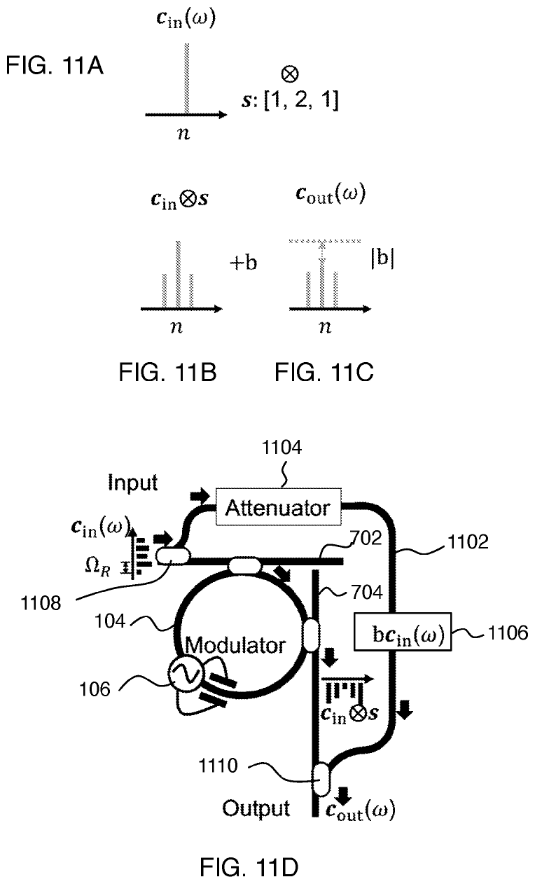

FIGS. 10A-F relate to convolution processing of the kernels generated from a modulated ring resonator with an input frequency comb consisting of multiple nonzero frequency comb lines. FIG. 10A is a comparison of the synthesized kernel and target kernel. The black bar/line corresponds to the real/imaginary part of the experimental kernel. The white bar/line corresponds to the real/imaginary parts of the target kernel. FIGS. 10B-C correspond to the input frequency comb measured from experiments. FIG. 10D shows measured time-resolved intensity from the drop-port of the modulated ring resonator I(Δω=0,t) for the kernel synthesis in FIG. 10A. FIGS. 10E-10F correspond to the output frequency comb measured (in darker gray) and expected (in lighter grey) outputs with the real and imaginary parts plotted in bar and lines respectively.

To start with we first synthesize a modified Laplacian kernel s₀=3 and s_{±1}=−1. This functions in a similar way as a high boost kernel introduced before, but the reduced so term enables an improved edge detection property. We follow the same procedure of applying a pre-determined modulation waveform, as introduced in previous sections. In FIG. 10A, we compare the kernel obtained from experiments and target designs. The sₙ from the experimental measurement is shown next to the sₙ from the target design. Both kernels are normalized such that Σn|sₙ|²=1. These two kernels agree well and verify that the modified Laplacian kernel is synthesized successfully. The slice of Δω=0 in the time- and frequency detuning resolved drop-port intensity measurement is shown in FIG. 10D, which shows a consistent line shape as in the high-boost kernel case. We emphasize that in this kernel synthesis example, there is no additive offset term involved.

To generate the input vector, we use a CW laser operating at a swept frequency across the resonant frequency of the ring and pass the output of the CW laser through an electro-optic amplitude modulator. The modulator is driven by an arbitrary waveform generator (AWG), which has frequency components of the FSR and its integer multiples. This modulation is periodic with a periodicity equal to the round trip time. Such a modulation results in a comb of discrete frequencies equally separated by FSR, which is injected into the ring.

The input vector thus generated can be characterized by measuring the time-dependent intensity Iᵢₙ(t) that is transmitted through the modulator. For an amplitude modulator, the amplitude of the transmitted light, up to a global phase that is unimportant, can be determined as Aᵢₙ(t)=\sqrt{Iᵢₙ(t)}. A Fourier transform of Aᵢₙ(t) then determines the input vector, i.e. the complex amplitudes of the input light at various frequencies.

FIGS. 10B and 10C show two different input vectors thus generated by applying multiple sinusoidal bands and a sharp pulse, respectively. We choose these two modulations to generate as broadband frequency combs as possible. For each of these input vectors, we send it through the setup corresponding to the kernel shown in FIGS. 10A, 10D. To determine the generated output vector, we measure the output intensity Iₒᵤₜ(t) as a function of time. Since only the amplitude modulator is used in synthesizing the kernels, we determine the output amplitude Aₒᵤₜ(t)=\sqrt{Iₒᵤₜ(t)}, we then Fourier transform Aₒᵤₜ(t) to obtain the output vector. The experimentally determined output vector agrees very well with the direct calculation of the convolution operation of the kernels on the input vectors using the output signal from FIG. 10D, as shown in FIGS. 10E-F. We have thus demonstrated that our setup can indeed achieve convolution operation in the synthetic frequency dimension.

### C4) Discussion

In summary, we experimentally demonstrate convolution operation in the synthetic frequency space. We show that the prescribed kernel can be implemented by an analytically determined modulation waveform applied to the electro-optic modulator. Our work demonstrates the promise of using frequency to encode data and implement convolution tasks. We anticipate that our demonstration of convolution operation via frequency synthetic dimensions may lead to new scalable photonic computation architecture types.

We note that throughout this section, we only use amplitude modulators, both for the generation of the input signals and for kernel synthesis. As a proof-of-principle experiment, this suffices to demonstrate a wide range of convolution. With the use of amplitude modulation only, the kernels that can be generated are restricted to being symmetric and real-valued, as theoretically proved above. Nevertheless, the operating principle of our setup can be directly applied to include a phase modulator for the synthesis of more complex kernels.

### C5) Methods

### C5a) Calibration of the Loss Rate

In this Section, we describe the experimental calibration process of γ+γ_{cst}. Without any modulation from the electro-optical modulator (JDSU model 10020476), we measure the output intensity I(Δω) from the drop-port of the ring resonator, in the same way as described in the main text. I(Δω) is related to γ+γ_{cst} by,

$$I ( Δω ) = {\vert \frac{2 j {γ}_{e 1} {γ}_{e 2}}{j γ + j {γ}_{cst} - Δ ω} \vert}^{2} . \qquad ( 45 )$$

We then perform the least square fitting of I(Δω) to obtain the optimal parameters of γ+γ_{cst}. In our system, the calibrated loss factor is γ+γ_{cst}=0.027Ω_{R}.

### C5b) Data Processing and Time Sequence Acquisition

In our experiments, we use a narrow-linewidth laser with tunable lasing frequency as input (ORION 1550 nm Laser Module) under an amplitude modulator (JDSU, model 10020476) controlled by the radio frequency signal from an Arbitrary Waveform Generator (AWG, AGILENT 33250A-U 80 MHz Function). We use an erbium-doped-amplifier (EDFA, IRE-POLUS, Model EAU-2M) to amplify the optical signal. We use an RF amplifier (Mini-Circuits, Model ZHL-3A+) to amplify the modulation signal.

To measure the time-dependent output intensity I(Δω,t) at the drop port, we use a photodiode (Thorlabs DET08CFC) with a 5 GHz bandwidth to detect the output signal and we use an oscilloscope (LeCroy LC584AL) with a bandwidth of 1 GHz to obtain a 1-ms time-sequence data. The 1-ms-long time-sequence data was then reshaped into multiple time sequences, one for a roundtrip time of the ring (1/(5.99 MHz)=167 ns).

We determine the starting time of one roundtrip sequence by comparing the intensity peak of the theoretical design peak location. We shift one sequence so that the experimental resonant peak is aligned with the designed peak. The entire measured time sequence is shifted by the same amount of time. We then unflatten the 1D data sequences along the vertical axis to obtain the 2D intensity measurement in FIGS. 8B and 8F and FIGS. 9D-F.

### C6) Schematic of an Experimental Setup to Realize the Additive Offset Term

Eq. (44) describes a mathematical model for an all-optical convolution operation. As a proposed setup, a pipeline consisting of three main steps, as well as an additional step for an all-optical realization of an additive offset term, is shown in FIGS. 11A-D and described below.

In FIG. 11A, the input vector cᵢₙ is convolved with a kernel vector s using a convolution operation, resulting in a vector of convolved values. In FIG. 11B, an additive offset term is applied to the result of the step of FIG. 11A. This additive offset term is obtained by multiplying the input cᵢₙ with a scalar value b, (b<0). In FIG. 11C, the output of this additive offset term operation is the output vector cₒᵤₜ, which represents the result of applying Eq. (44) to the input vector. This approach allows for the realization of an additive offset term in an all-optical way, which can be useful for implementing all-optical neural networks or other optical signal processing applications.

As shown in FIG. 11D, in this all-optical implementation, the input light is passed through a beam splitter, which separates the light into two paths. In the first path 1102, a π phase shifter and an attenuator or amplifier 1106 are used to implement the operation of the first term in Eq. (7). The attenuator or amplifier 1106 is used to adjust the amplitude of the input signal by a scalar factor b. Optionally, two components 1104 and 1106 can be used for this function. The π phase shift (i.e. a sign change) can be implemented separately (not shown) or by the amplifier or attenuator.

In the second path, a modulated fiber ring setup as described above is used to implement the operation of the second term in Eq. (44). This involves passing the input light through a fiber ring resonator that is modulated by a signal that represents the convolution kernel {sₙ} in Eq. (44). The modulated fiber ring setup operates in the same way as described in the main text to generate a pre-designed kernel sₙ with electro-optical modulation.

The transmitted lights from the two paths are then combined to realize Eq. (44). Specifically, the two light paths are recombined using a beam splitter, which adds the signals from the two paths. This results in an output signal that is proportional to the sum of the two terms in Eq. (44).

Overall, this implementation broadens the range of kernels that we can implement in the fiber ring system. Our proposed setup allows for the all-optical realization of Eq. (44) using simple optical components such as beam splitters, phase shifters, and fiber ring resonators. This approach has the potential to enable the development of all-optical neural networks and other optical signal processing applications with high speed, low energy, and high bandwidth consumption.

1. Apparatus comprising:
an optical resonator coupled to at least one optical waveguide;
wherein the optical resonator includes an amplitude modulator and a phase modulator;
wherein the optical resonator is configured to receive a waveguide input that is an optical frequency comb having multiple optical frequency components;
a signal controller configured to electrically drive the amplitude modulator with a composite amplitude electrical signal, and configured to electrically drive the phase modulator with a composite phase electrical signal;
wherein the composite amplitude electrical signal includes two or more electrical frequency components;
wherein the composite phase electrical signal includes the two or more electrical frequency components;
wherein the composite amplitude electrical signal and the composite phase electrical signal are selected to implement a predetermined convolution kernel;
whereby an input-output relation between the waveguide input and a waveguide output of the optical resonator is a convolution using frequencies of the optical frequency comb as a basis.

2. The apparatus of claim 1, wherein a free spectral range of the optical resonator is the same as a frequency spacing of the optical frequency comb.

3. The apparatus of claim 1, wherein the convolution kernel is selected from the group consisting of: 1-D convolution kernels, 2-D convolution kernels, and 3-D convolution kernels.

4. The apparatus of claim 1, wherein the convolution kernel is selected from the group consisting of: Gaussian kernels, Laplacian kernels, Sobel x kernels, and Sobel y kernels.

5. The apparatus of claim 1, wherein an input 2-D or 3-D data set is divided into nonoverlapping partial data sets to reduce a bandwidth of the composite electrical amplitude and phase signals needed to implement the convolution kernel.

6. The apparatus of claim 1, wherein the composite electrical amplitude and phase signals are determined in closed form from the convolution kernel.

7. The apparatus of claim 1, further comprising an optical splitter, an optical combiner, and an optical loss/gain element,
wherein an optical input is received by the optical splitter and divided into the waveguide input and a single-frequency offset optical input;
wherein the single-frequency offset optical input is received by the optical loss/gain element to provide an adjusted offset;
wherein the adjusted offset and the waveguide output is combined with the optical combiner;
whereby an additive offset term in the convolution kernel is implemented by the optical loss/gain element.

8. The apparatus of claim 1, wherein a single optical waveguide provides the waveguide input and receives the waveguide output.

9. The apparatus of claim 1, wherein an input optical waveguide provides the waveguide input and wherein an output optical waveguide receives the waveguide output.
